(19) United States
(12) Patent Application Publication
(10) Pub. No.: US 2014/0156551 A1
(43) Pub. Date: Jun. 5, 2014

(54) SYSTEM AND METHOD FOR CONSTRUCTING A UNIVERSITY MODEL GRAPH

(71) Applicant: SRM INSTITUTE OF SCIENCE AND TECHNOLOGY, Chennai (IN)

(72) Inventors: Sridhar Varadarajan, Bangalore (IN); Srividya Gopalan, Bangalore (IN); Preethy Iyer, Bangalore (IN)

(73) Assignee: SRM INSTITUTE OF SCIENCE AND TECHNOLOGY, Chennai (IN)

(21) Appl. No.: 14/081,407

(22) Filed: Nov. 15, 2013

Related U.S. Application Data
(63) Continuation-in-part of application No. 12/945,582, filed on Nov. 12, 2010, now abandoned.

(30) Foreign Application Priority Data
Jun. 28, 2010 (IN) 1809/CHE/2010

(51) Int. Cl. G06Q 50/20; G06Q 10/00

(52) U.S. Cl. CPC G06Q 50/2053; G06Q 10/00
USPC 705/327

(57) ABSTRACT

An educational institution (also referred as a university) is rich with multiple kinds of data: students, faculty members, departments, divisions, and at university level. Relating and correlating this data at and across various levels help in obtaining a perspective about the educational institution. A structural representation captures the essence of all of the relationships in a unified manner and an important aspect of the relationship is the so-called “influence factor.” This factor indicates influencing effect of an entity over another entity, wherein the entities are a part of the structural representation. A system and method for the construction of such a structural representation of an educational institution based on the educational institution specific information is discussed.

A reference is made to the applicants' earlier Indian patent application number 1269/CHE2010 filed on 6 May 2010.

### FIELD OF THE INVENTION

The present invention relates to the construction of a structural representation of a university in general, and more particularly, semi-automated construction of the structural representations. Still more particularly, the present invention relates to a system and method for semi-automatic construction of a model graph associated with a university.

### BACKGROUND OF THE INVENTION

An educational institution (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (I) News and Events; (m) Alumni; and (n) Information Resources. In order to be able to assess the university in a manner for to be used for multiple purposes such as for prospective students, candidates exploring opportunities within the university, for the funding agencies, and for providing an objectivized assessment information for the university visitors, there is a need to construct a structural representation of the university based on the known information about the university. This constructed structural representation forms the basis for helping prospective students to have a better understanding of the university they are exploring to enroll and helping funding agencies to get a better picture of the university that they are planning to fund.

2. Description of Related Art

United States Patent Application 20090191527 titled “Systems and Methods for Assisting an Educational Institution in Rating a Constituent” by King; Melissa; (West Chester, Pa.); Mendonca; Denise Marie; (San Diego, Calif.); Packard; Patrick; (Hingham, Mass.); Reber; Martin Donald; (Coatesville, Pa.); Rullo; Robert David; (West Chester, Pa.) (filed on Feb. 6, 2008 and assigned to SunGard Higher Education Inc. Malvern, Pa.) describes a system for a graphical display of a probability and desirability value for a person at a stage of a student life cycle. For example, the higher education relationship system may receive a history of interactions between the person and the institution and may use these interactions and information about the person to calculate the measure of the likelihood that the person moves to another stage in the student life cycle, and the desirability value, or a measure of the appeal of the person to the educational institution at a stage of the student life cycle.

“The Governance and Performance of Research Universities: Evidence from Europe and the U.S.” by Aghion; Philippe, Dewatripont; Mathias Dewatripont, Hoxby; Caroline, Mas-Colell; Andreu, and Sapir; André (Working Paper 14851, NBER Working Paper Series, National Bureau of Economic Research, Cambridge, Mass. 02138, April 2009) describes how university governance affects research output, measured by patenting and international university research rankings.

“A model of assessment in higher education institutions” by Joughin; Gordon and Macdonald; Ranald (Article, The Higher Education Academy, 2004) describes a model of the complex phenomenon of assessment in higher education based on four principle levels.

“Academic Institution Internal Structure Ontology (AIISO)” from the website url “http://vocab.org/aiiso/schema” (with the latest version available at “http://purl.org/vocab/aiiso/schema#” (accessed on 17 May 2010), May 2008) provides classes and properties to describe the internal organizational structure of an academic institution.

“Decision Support System for Managing Educational Capacity Utilization in Universities” by Vinnik; Svetlana and Scholl; Marc (appeared in the Proceedings of International Conference on Engineering and Computer Education (ICECE'05), Madrid, Spain from Nov. 13-Nov. 16, 2005) describes a methodology for assessing educational capacity and planning its distribution and utilization in universities.

The known systems do not address the issue of a comprehensive modeling of an educational institution at various levels in order to be able to assess the educational institution at various levels. The present invention provides for system and method for a comprehensive modeling of the educational institution at multiple levels based on a set of entities and the mutual influences among these entities.

### SUMMARY OF THE INVENTION

The primary objective of the invention is to model an educational institution in a comprehensive manner for helping in the assessment of the educational institution at elemental and component levels.

One aspects of the present invention is to construct a university model graph of an educational institute that provides the structural representation of the educational institution.

Another aspect of the invention is to model an entity of the educational institution using a defined parametric model.

Yet another aspect of invention is to model an entity of the educational institution using a defined hierarchical model.

Another aspect of the invention is to model an entity of the educational institution using a defined activity based model.

Yet another aspect of the invention is to model the educational institution using a list of positive influencers related to a pair of entities of the educational institution.

Another aspect of the invention is to model the educational institution using a list of negative influencers related to a pair of entities of the educational institution.

Yet another aspect of the invention is to assess an entity and the instances of the entity using a plurality of models associated with the entity of the educational institution.

Another aspect of the invention is to compute the mutual influences between an instance of an entity and another instance of another entity of the educational institution.

Yet another aspect of the invention is to compute the mutual influences between a pair of entities of the educational institution.

Another aspect of the invention is to compute the mutual influences between an instance of an entity and another entity of the educational institution.

Yet another aspect of the invention is to compute the mutual influences between an entity and an instance of another entity of the educational institution.

Yet another aspect of the invention is to construct a university model graph based on entity assessments, entity instance assessments, and mutual influences between (a) a pair of entity instances, (b) a pair of entities, (c) an instance of an entity and another entity; and (d) an entity and an instance of another entity.

In a preferred embodiment of the present invention provides a system for the construction of a university model graph of a university based on a plurality of assessments and a plurality of influence values to assist in the assessment of said university at multiple levels using a university database, a university knowledgebase, a plurality of models and a plurality of influencers, wherein said university comprises of a plurality of entities and a plurality of entity-instances, wherein each of said plurality of entity-instances is an instance of an entity of said plurality of entities, and said university model graph comprises of a plurality of abstract nodes, a plurality of nodes, a plurality of abstract edges, a plurality of semi-abstract edges, and a plurality of edges,

with each abstract node of said plurality of abstract nodes corresponding to an entity of said plurality of entities,

each node of said plurality of nodes corresponding to an entity-instance of said plurality of entity-instances, and

each abstract node of said plurality of abstract nodes is associated with a model of said plurality of models, and

a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,

a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;

a source node of said plurality of nodes is connected to a destination node of said plurality of nodes by a directed edge of said plurality of edges and said directed edge is associated with an influence value of said plurality influence values, wherein said influence value is a value between −1 and +1;

a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and

a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1,

said system comprising:
means for obtaining of said plurality of models, wherein said plurality of models comprises a plurality of parametric models, a plurality of hierarchical models, and a plurality of activity based models;
means obtaining of said plurality of influencers associated with a pair of entities wherein each of said pair of entities is a part of said plurality of entities;
means for computing of an entity-instance assessment of said plurality of assessments, wherein said entity-instance assessment is associated with an entity-instance of said plurality of entity-instances;
means for assigning of said entity-instance assessment to an entity-instance node of said plurality of nodes, wherein said entity-instance node is associated with said entity-instance; (assignments are part of the sub-claims)
means for computing of an entity assessment of said plurality of assessments, wherein said entity assessment is associated with an entity of said plurality of entities;
means for assigning of said entity assessment to an entity abstract node of said plurality of abstract nodes, wherein said entity abstract node is associated with said entity;
means for computing of an influence value, of said plurality of influence values, associated with a source entity-instance and a destination entity-instance, wherein said source entity-instance is a part of said plurality of entity-instances and said destination entity-instance is a part of said plurality of entity-instances;
means for assigning of said influence value to a directed link, of said plurality of links, from a source node of said plurality of nodes to a destination node of said plurality of nodes, wherein said source node is associated with said source entity-instance and said destination node is associated with said destination entity-instance;
means for computing of an entity influence value, of said plurality of influence values, associated with a source entity and a destination entity, wherein said source entity is a part of said plurality of entities and said destination entity is a part of said plurality of entities;
means for assigning of said entity influence value to a directed abstract link, of said plurality of abstract links, from a source abstract node of said plurality abstract nodes to a destination abstract node of said plurality of abstract nodes, wherein said source abstract node is associated with said source entity and said destination abstract node is associated with said destination entity;
means for computing of an entity-instance-entity-influence value, of said plurality of influence values, associated with a source entity-instance and a destination entity, wherein said source entity-instance is a part of said plurality of entity-instances and said destination entity is a part of said plurality of entities;
means for assigning of said entity-instance-entity-influence value to a directed semi-abstract link, of said plurality of semi-abstract links, from a source node of said plurality of nodes to a destination abstract node of said plurality of abstract nodes, wherein said source node is associated with said source entity-instance and said destination abstract node is associated with said destination entity;
means for computing of an entity-entity-instance-influence value, of said plurality of influence values, associated with a source entity and a destination entity-instance, wherein said source entity is a part of said plurality of entities and said destination entity-instance is a part of said plurality of entity-instances; and
means for assigning of said entity-entity-instance-influence value to a directed semi-abstract link, of said plurality of semi-abstract links, from a source abstract node of said plurality of abstract nodes to a destination node of said plurality of nodes, wherein said source abstract node is associated with said source entity and said destination node is associated with said destination entity-instance. (BASED ON FIGS. 1, 1b, 1c, and 8)

### BRIEF DESCRIPTION OF THE DRAWINGS

FIG. 1 depicts an overview of UMG Construction System.

FIG. 1a depicts a partial list of entities of a University.

FIG. 1b depicts an illustrative University Model Graph.

FIG. 1c provides a University Model Graph Construction Matrix.

FIG. 1d provides the elements of a University Model Graph.

FIG. 2 describes the notions of Entity Assessment.

FIG. 2a describes the notations related to Entity Assessment.

FIG. 3 describes approaches for Entity Assessment.

FIG. 3a provides additional information about approaches for Entity Assessment.

FIG. 4 describes Entity-Instance Assessment Computation.

FIG. 4a provides additional information about Entity-Instance Assessment Computation.

FIG. 4b depicts Entity Assessment Computation.

FIG. 5 depicts an illustrative Entity and Entity-Instance Assessment Models.

FIG. 5a depicts additional illustrative Entity and Entity-Instance Assessment Models.

FIG. 5b depicts additional illustrative Entity and Entity-Instance Assessment Models.

FIG. 6 depicts an illustrative Entity-Instance Assessment.

FIG. 6a depicts an illustrative Entity Assessment.

FIG. 6b depicts an illustrative Entity Assessment based on Hierarchical Modeling.

FIG. 6c depicts an illustrative Entity-Instance Assessment based on Activity based Modeling.

FIG. 7 describes the aspects of I-Value Computation.

FIG. 7a provides additional information about the aspects of I-Value Computation.

FIG. 8 describes a system for UMG Construction.

FIG. 8a describes a sub-system for I-Value Computation.

FIG. 8b describes an approach for I-Value Computation.

FIG. 8c depicts an illustration of EI-Value, IEEI-Value, and EIEI-Value Computations.

FIG. 8d depicts an approach for EI-Value, IEEI-Value, and EIEI-Value Computations.

FIG. 9 provides an illustrative LoPI related to STUDENT and FACULTY MEMBER.

FIG. 9a provides an illustrative LoNI related to STUDENT and FACULTY MEMBER.

FIG. 9b provides an illustrative LCOT related to STUDENT and FACULTY MEMBER.

FIG. 9c provides an illustrative Computation of II-Array related to FM Instance.

FIG. 9d provides an illustrative Computation of AI0 related to FM Instance.

FIG. 9e provides an illustrative Computation of II-Value 2 related to FM Instance.

FIG. 9f provides an illustrative Computation of I-Value related to FM Instance.

FIG. 9g provides an illustrative Depiction of I-Value related to FM Instance.

FIG. 9h provides an illustrative Computation of EI-Value, IEEI-Value, and EIEI-Value related to FM and S.

FIG. 9i provides an illustrative Depiction of EI-Value related to FM and S.

FIG. 9J provides the summary of Four Influence Values related to FM and S.

FIG. 10 depicts an illustrative University Modeling System.

FIG. 11 provides an illustrative set of attributes for Student assessment.

FIG. 11A provides an approach for computing student assessment.

FIG. 11B provides an approach for Test Factor computation.

FIG. 11C depicts an illustrative data for assessment of students.

FIG. 11D provides illustrative test marks of a student.

FIG. 11E depicts an illustrative set of clusters.

FIG. 11F depicts the computed Test Factor of a student.

FIG. 12 provides an approach for computing influence value.

FIG. 12A depicts an illustrative impact assessment.

FIG. 12B provides an illustrative influence value computation.

### DETAILED DESCRIPTION OF THE PREFERRED EMBODIMENTS

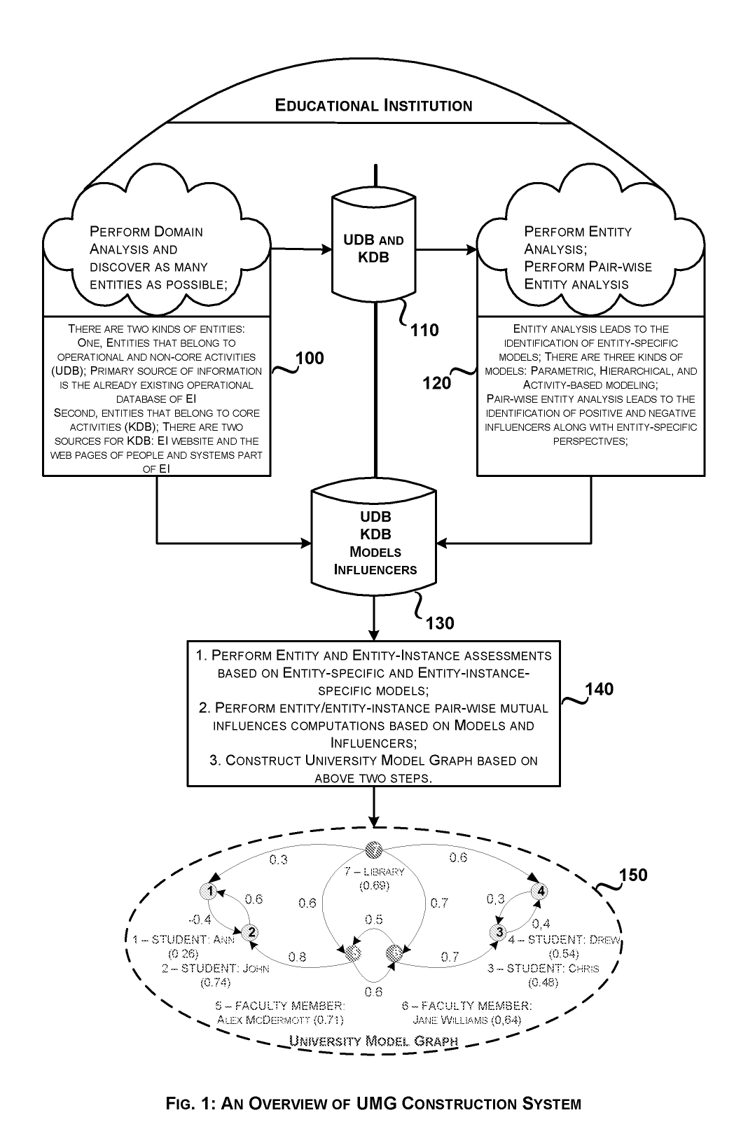

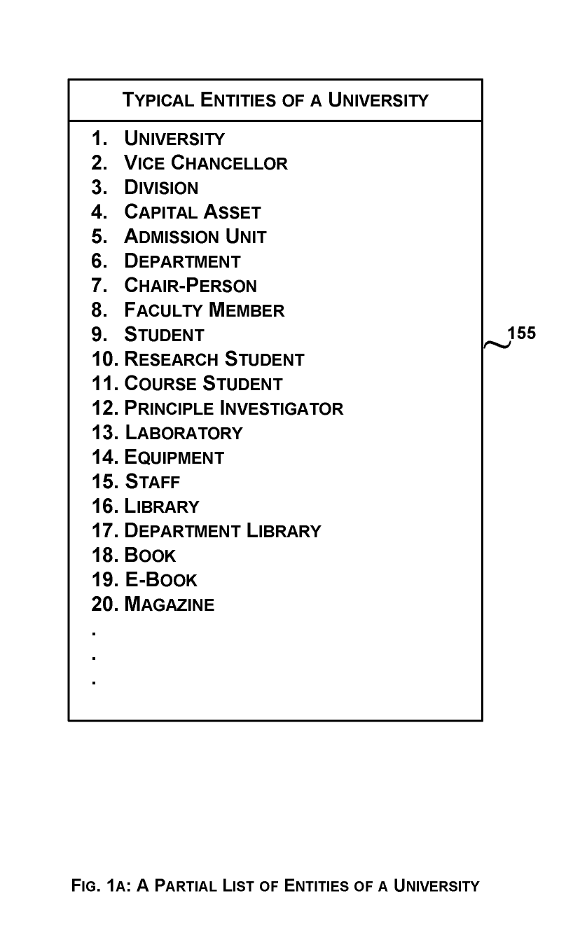

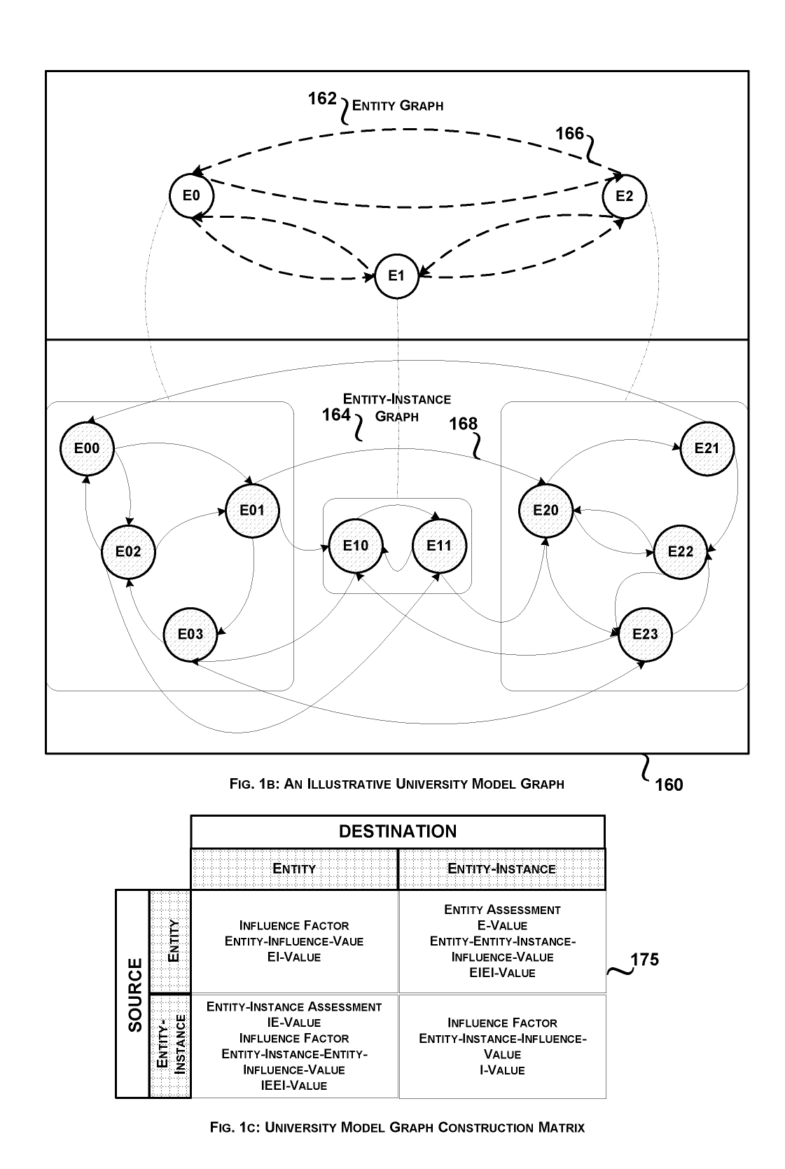

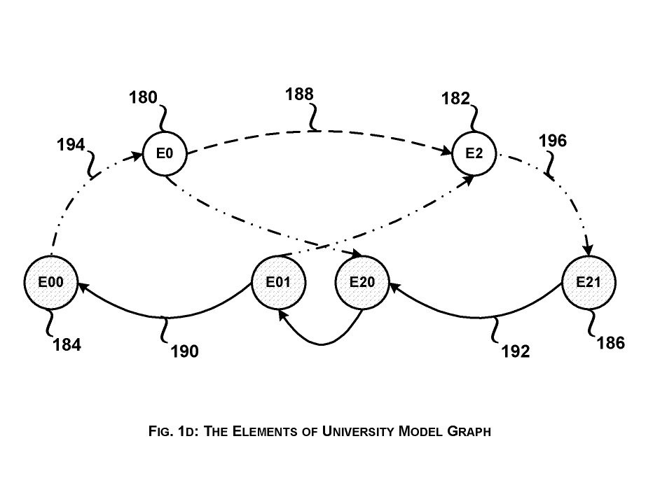

FIG. 1 depicts an overview of UMG Construction System. The Universal Model Graph of an educational institution (or equivalently, a university) is a structural representation of the information about the educational institution and helps in the assessment of the educational institution at various levels. An important aspect of the assessment is the identification of the entities of interest of the educational institution. There are two kinds of entities:

One, Entities that belong to operational and non-core activities (UDB); Primary source of information is the already existing operational database of EI; and

Second, entities that belong to core activities (KDB); There are two sources for KDB: EI website and the web pages of people and systems part of EI.

Perform Domain Analysis and discover as many entities as possible (100) and this results in the updated UDB and KDB (110).

In the next step, Perform Entity Analysis; and Perform Pair-wise Entity analysis (120).

Entity analysis leads to the identification of entity-specific models; There are three kinds of models: Parametric, Hierarchical, and Activity-based modeling;

Pair-wise entity analysis leads to the identification of positive and negative influencers along with entity-specific perspectives.

This leads to the updated databases (130).

The major steps involved in the process of UMG construction are as follows (140):

1. Perform Entity and Entity-Instance assessments based on Entity-specific and Entity-instance-specific models;

2. Perform entity/entity-instance pair-wise mutual influences computations based on Models and Influencers; and

3. Construct University Model Graph based on above two steps.

An illustrative UMG is depicted in 150. The nodes 1, 2, 3, and 4 are instances of STUDENT entity and the numerical value (<1) indicates the entity-instance assessment. For example, the assessment of John Abraham is 0.74. Similarly, the other nodes also stand for entity instances: nodes 5 and 6 are instances of the entity FACULTY MEMBER while node 7 is an instance of entity LIBRARY. Note that if there is only one entity instance for an entity (say, LIBRARY), then the entity and the entity instance are used interchangeably. The directed edges (or equivalently, links) depict the nature and quantum of influences: for example, the directed edge (link) from node 5 to node 2 indicates a positive influence of 0.8 by the faculty member Alex McDermott on the student John Abraham.

FIG. 1a depicts a partial list of entities of a University. Some of the critical entities include UNIVERSITY, FACULTY MEMBER, STUDENT, and LIBRARY (155).

FIG. 1b depicts an illustrative University Model Graph. 160 describes UMG as consisting of two main components: Entity Graph (162) and Entity-Instance Graph (164). Entity graph consists of entities of the university as its nodes and an abstract edge (166) or abstract link is a directed edge that connects two entities of the entity graph. The weight associated with this abstract edge is the influence factor or influence value indicating nature and quantum of influence of the source entity on the destination entity. Similarly, the nodes in the entity-instance graph are the entity instances and the edge (168) or the link between two entity-instances is a directed edge and the weight associated with the edge indicates the nature and quantum of influence of the source entity-instance on the destination entity-instance.

FIG. 1c provides a University Model Graph Construction Matrix. 175 showing the various elements of the matrix. The rows are labeled as Entity and Entity-Instance, and the columns are also similarly labeled. The element corresponding to Source Entity—Destination Entity indicates the influence factor or influence value (EI-Value) associated with Source Entity with respect to Destination Entity. That is, EI-Value indicates how a source entity influences a destination entity. Similarly, the element Source Entity-Instance—Destination Entity-Instance indicates the influence factor or value (I-Value) associated with Source Entity-Instance with respect to Destination Entity-Instance. That is, I-Value indicates how a source entity instance influences a destination entity instance. The element related to Entity-Instance and Entity indicates the influence factor or value (IEEI-Value) associated with the Source Entity-Instance with respect to Destination Entity. Finally, the element related to Entity and Entity-Instance indicates the influence factor or value (EIEI-Value) associated with the Source Entity with respect to Destination Entity-Instance. Further, these two elements also indicate the Entity assessment (E-Value) and the Entity-Instance assessment (IE-Value). Thus two assessments and four influence factors or values form the most significant ingredients of the university model graph.

FIG. 1d provides the elements of a University Model Graph. The fundamental elements are nodes and edges. There are two kinds of nodes: Abstract nodes (180 and 182) and Nodes (184 and 186); There are three kinds of directed edges or links: Abstract links (188), links (190 and 192), and semi-abstract links (194 and 196). As part of the modeling, the abstract nodes are mapped onto entities and nodes are mapped onto the instances of the entities; an abstract link corresponds to an EI-Value, a semi-abstract link corresponds to either an EIEI-Value or an IEEI-Value, and finally, a link corresponds to an I-Value. Note that edges and links are used interchangeably. Further, each entity is associated with a model and an instance of an entity is associated with a base score and an instantiated model, wherein the base score is computed based on the associated instantiated model.

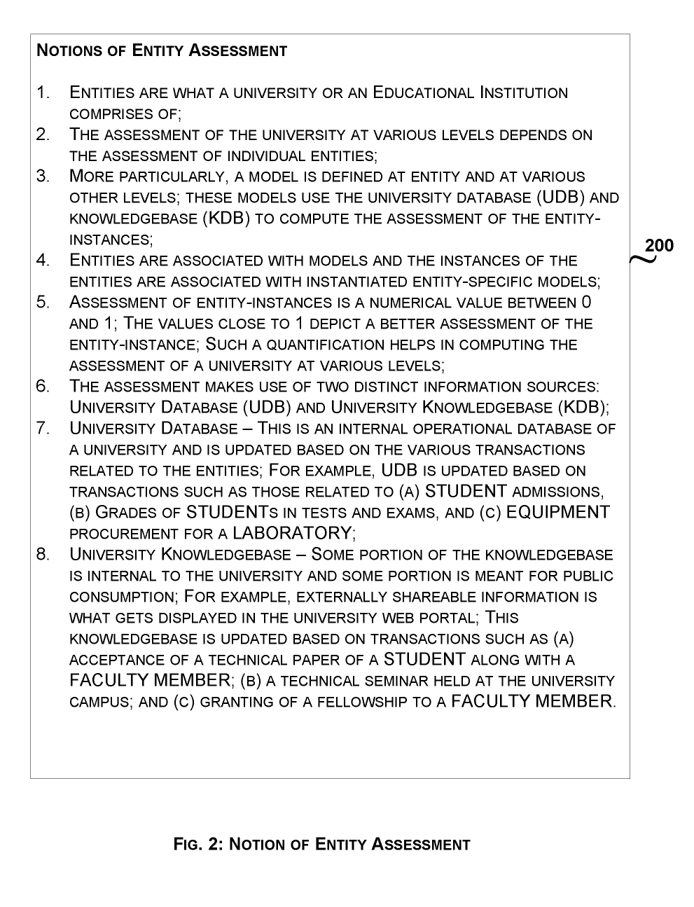

FIG. 2 describes the notions of Entity Assessment.

Notions of Entity Assessment (200):

1. Entities are what a university or an Educational Institution comprises of;

2. The assessment of the university at various levels depends on the assessment of individual entities;

3. More particularly, a model is defined at entity and at various other levels; these models use the university database (UDB) and knowledgebase (KDB) to compute the assessment of the entity-instances;

4. Entities are associated with models and the instances of the entities are associated with instantiated entity-specific models;

5. Assessment of entity-instances is a numerical value between 0 and 1; The values close to 1 depict a better assessment of the entity-instance; Such a quantification helps in computing the assessment of a university at various levels;

6. The assessment makes use of two distinct information sources: University Database (UDB) and University Knowledgebase (KDB);

7. University Database—This is an internal operational database of a university and is updated based on the various transactions related to the entities; For example, UDB is updated based on transactions such as those related to (a) STUDENT admissions, (b) Grades of STUDENTs in tests and exams, and (c) EQUIPMENT procurement for a LABORATORY;

8. University Knowledgebase—Some portion of the knowledgebase is internal to the university and some portion is meant for public consumption; For example, externally shareable information is what gets displayed in the university web portal; This knowledgebase is updated based on transactions such as (a) acceptance of a technical paper of a STUDENT along with a FACULTY MEMBER; (b) a technical seminar held at the university campus; and (c) granting of a fellowship to a FACULTY MEMBER.

FIG. 2a describes the notations related to Entity Assessment.

Notations related to Entity Assessment (250):

UDB University operational Database

KDB University Knowledgebase

PM Parametric Modeling

HM Hierarchical Modeling

AM Activity based Modeling

E Entity

IE Instance of an Entity

P Parameter

SP Set of Parameters

P-Value Parameter Value

PF Parameter Function

PMF Parametric Model Function

IE-Value Entity-Instance Value

E-Value Entity Value

H Hierarchy

EH Entity Hierarchy

SubE Sub-entity of Entity

SSE Set of Sub-Entities of Entity

LE Leaf-level Entity

NLE Non-Leaf-level Entity

RE Root Entity

LEF Leaf-level Function

NLEF Non-Leaf-level Function

RF Root level Function

LE-Value Leaf-level Entity Value

NLE-Value Non-Leaf-level Entity Value

RE-Value Root Entity Value

A Activity

AH Activity Hierarchy

SubA Sub-activity of Activity

SSA Set of Sub-Activities

SA Set of Activities

LA Leaf-level Activity

NLA Non-Leaf-level Activity

LAF Leaf-level Activity Function

NLAF Non-Leaf-level Activity Function

LA-Value Leaf-level Activity Value

NLA-Value Non-Leaf-level Activity Value

IA-Value Entity-Instance Value

AI Assessment of Instance; stands for either IE-Value or IA-Value

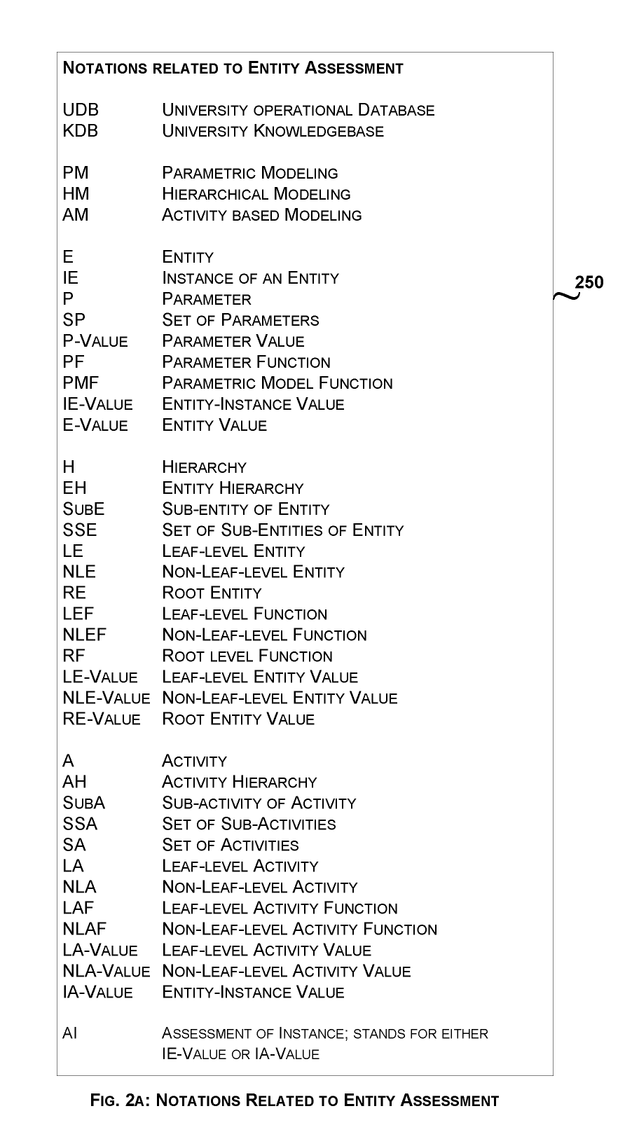

FIG. 3 describes approaches for Entity Assessment.

Approaches for Entity Assessment (300):

1. Three kinds of entity assessment based on the means for obtaining the various models:
Parametric Modeling (PM);
Hierarchical Modeling (HM); and
Activity based Modeling (AM).

2. Parametric modeling—elaborating the means for obtaining of parametric models:
(a) Description: An entity E is analyzed and key parameters related to the entity are identified; for each such parameter, determine the parameter type (such as numeric), range (such as between 0 and 1), data elements, SDE, from UDB and KDB, and a function or rule, PF, to compute the parameter value based on SDE;
(b) Computation: Let SP={P1, P2, . . . , Pn} be the set of parameters associated with entity E; Define a PMF, a parametric modeling function associated with entity E based on SP.

3. Hierarchical Modeling—elaborating the means for obtaining of hierarchical models:
(A) Description: An entity E is analyzed and described in terms of a finite number of sub-entities, SSE, comprising E11, E12, . . . , E1A; Note that each sub-entity is a division of said entity; Similarly, each sub-entity E1i is analyzed and described in terms of a finite number of its sub-entities: E1i1, E1i2, . . . , E1iB;
This process is continued until the identified sub-entities are sufficiently atomic;
The entire set of E and the sub-entities form a hierarchy H with E at its root;
Note that each node in the hierarchy is associated with an entity or sub-entity;
For each entity SubE at the leaf level (LE) or at non-leaf level (NLE),
Determine a set of parameters, SP;
For each such parameter, determine the parameter type (such as numeric), range (such as between 0 and 1), data elements, SDE, from UDB and KDB, and a function or rule, PF, to compute the parameter value based on SDE;

(B) Computation: For each leaf-level entity, LE,
Let SP={P1, P2, . . . , Pn} be the set of parameters associated with entity LE;
Define LEF, a function associated with the entity LE based on SP;
For each non-leaf level entity NLE,
Let SSE={SubE1, SubE2, . . . , SubEn} be the set of sub-entities that are associated with NLE;
Let SP={P1, P2, . . . , Pn} be the set of parameters associated with entity NLE;
Define NLEF, a function associated with the entity NLE based on SSE and SP;

FIG. 3a provides additional information about approaches for Entity Assessment. Approaches for Entity Assessment (Contd.) (350)

4. Activity based Modeling—elaborating the means for obtaining of activity based models:
(A) Description: An entity E is analyzed and described in terms a set of activities, SA, such that the activities are relevant with respect to E;
Let SA={A1, A2, . . . , An} be a set of such activities;
For each activity Ai, perform one of the following:
(A1) Analyze and determine a set of parameters, SP={P1, P2, . . . , Pn} associated with Ai;
For each parameter Pi of SP, determine parameter type, range of values, data elements, SDE, of UDB and KDB, and a function or rule, PF, to determine the parameter value based on SDE;
(A2) Analyze and determine a set of sub-activities, SSA={Ai1, Ai1, . . . , Aib}. Note that each sub-activity is a division of the activity Ai and can be an atomic entity;
Further, Analyze and determine a set of parameters, SP={P1, P2, . . . , Pn} associated with Ai;
For each parameter Pi of SP, determine parameter type, range of values, data elements, SDE, of UDB and KDB, and a function or rule, PF, to determine the parameter value based on SDE;

(B) Computation: For each leaf-level activity, Sub-A,
Let SP={P1, P2, . . . , Pn} be the set of parameters associated with entity Sub-A;
Define LEF, a function associated with the activity Sub-A based on SP
For each non-leaf level activity Sub-A, Let SSA={SA1, SA2, . . . , SAn} be the set of sub-activities that are associated with Sub-A;
Let SP={P1, P2, . . . , Pn} be the set of parameters associated with activity Sub-A;
Define PF, a function associated with the activity Sub-A based on SSA and SP;

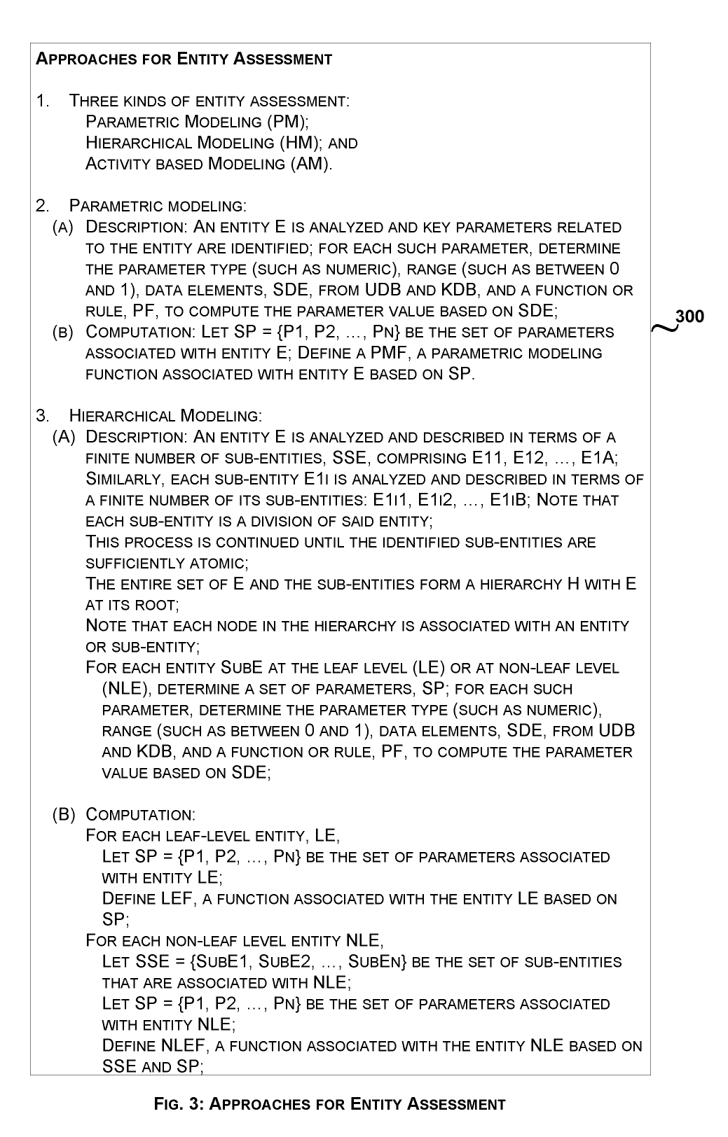

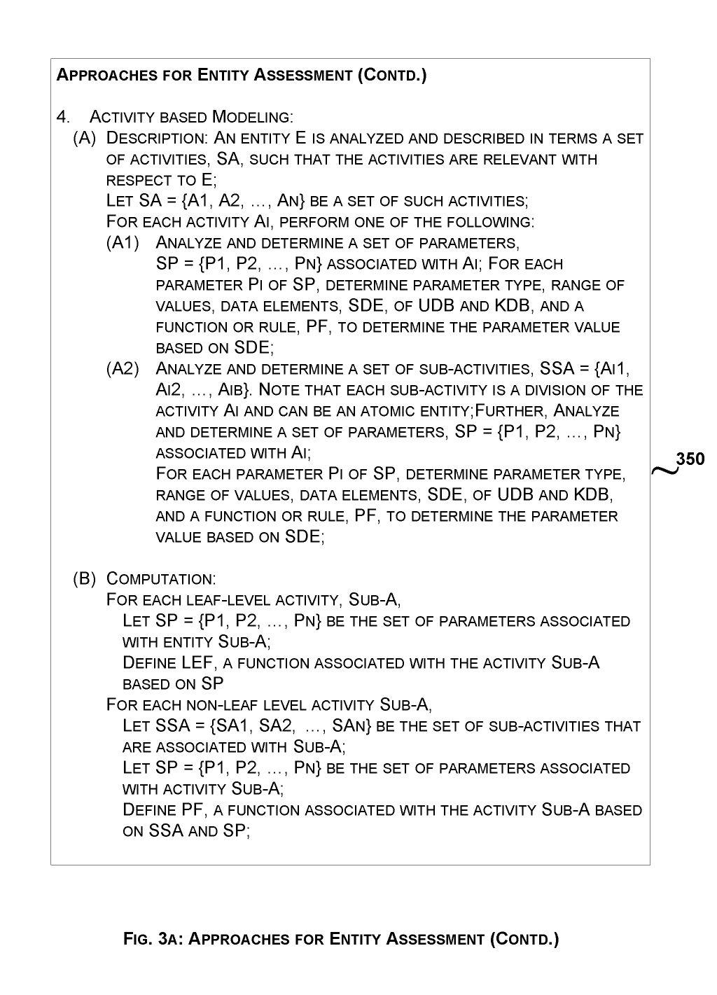

FIG. 4 describes Entity-Instance Assessment Computation.

Means for Computation of Entity-Instance Assessment (400):

Step 1: Let SE be the set of entities associated with an EI;

Step 2: For each entity E of SE

Step 21: Determine the set SIE, the instances of E based on UDB and KDB;

Step 22: For each IE of SIE,

Step 221: Determine model M associated with E;

Step 222: CASE M=PM:
Obtain a parametric model instance of M associated with IE;
Obtain SP associated with the parametric model instance;
For each P of SP,
   Obtain PF associated with P;
   Compute P-Value based on PF, UDB, KDB, and IE;
   Add P-Value to SP-Value;
Obtain PMF associated with the parametric model instance;
Compute IE-Value based on PMF and SP-Value;

Step 223: CASE M=HM:
Obtain an Entity Hierarchical Model instance of M associated with IE;
Obtain Entity Hierarchy EH of the Entity Hierarchical Model instance;
For each Leaf entity LE of EH,
   Obtain SP associated with LE;
   For each P of SP,
      Obtain PF associated with P;
      Compute P-Value based on PF, UDB, KDB, and IE;
      Add P-Value to SP-Value;
   Obtain LEF associated LE;
   Compute LE-Value based on LEF and SP-Value;
For each non-Leaf entity NLE of EH,
   Obtain SP associated with NLE;
   For each P of SP,
      Obtain PF associated with P;
      Compute P-Value based on PF, UDB, KDB, and IE;
      Add P-Value to SP-Value;
   Obtain SSE associated with NLE;
   Compute SNLE-Value based on LE-Value or NLE-Value associated with each of SSE;
   Obtain NLEF associated with NLE;
   Compute NLE-Value based on NLEF, SNLE-Value, and SP-Value;
Compute IE-Value based on NLE-Value associated with root of EH;

FIG. 4a provides additional information about Entity-Instance Assessment Computation. Means for Computation of Entity-Instance Assessment (Contd.) (450):

Step 224: CASE M=AM:
Obtain an Activity Hierarchical Model instance of M associated with IE;
Obtain Activity Hierarchy AH of the Activity Hierarchical Model instance;
For each Leaf Activity LA of AH,
   Obtain SP associated with LA;
   For each P of SP,
      Obtain PF associated with P;
      Compute P-Value based on PF, UDB, KDB, and IE;
      Add P-Value to SP-Value;
   Obtain LAF associated LA;
   Compute IA-Value based on LAF and SP-Value;
For each non-Leaf Activity NLA of AH,
   Obtain SP associated with NLA;
   For each P of SP,
      Obtain PF associated with P;
      Compute P-Value based on PF, UDB, KDB, and IE;
      Add P-Value to SP-Value;
   Obtain SSA associated with NLA;
   Compute SNLA-Value based on LA-Value or NLA-Value associated with each of SSA;
   Obtain NLAF associated with NLA;
   Compute NLA-Value based on NLAF, SNLA-Value, and SP-Value;
Compute IA-Value based on NLA-Value associated with root of AH;

Step 3: END.

FIG. 4b depicts Entity Assessment Computation.

Means for Computation of Entity Assessment (470):

Step 1: Let SE be the set of entities associated with an EI;

Step 2: For each entity E of SE

Step 21: Determine the set SIE, the instances of E based on UDB and KDB;

Step 22: Determine SIE-Value, a set of IE-Values based on SIE;

Step 23: Determine E-Value based on SIE-Value;

Step 3: END.

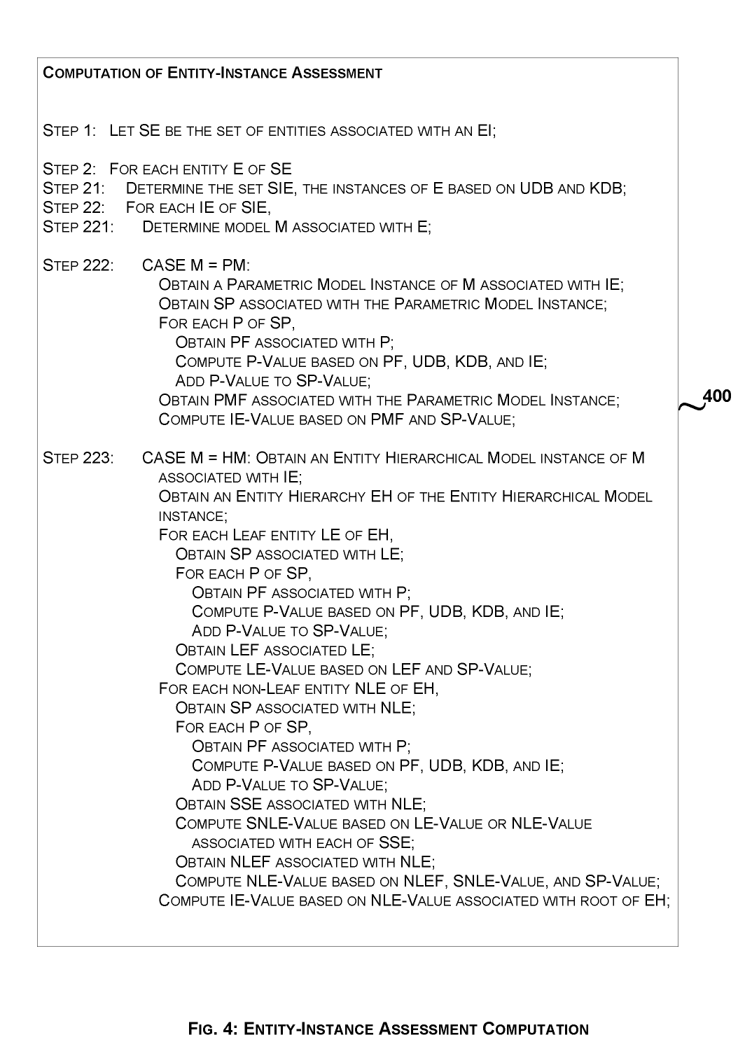

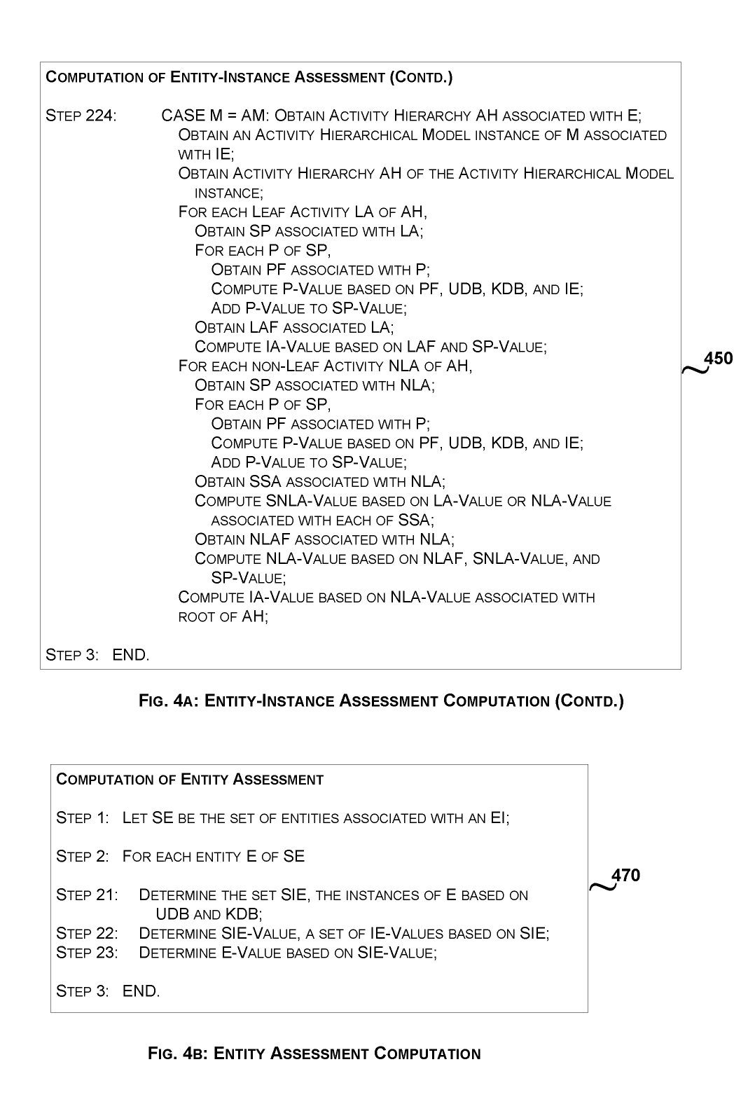

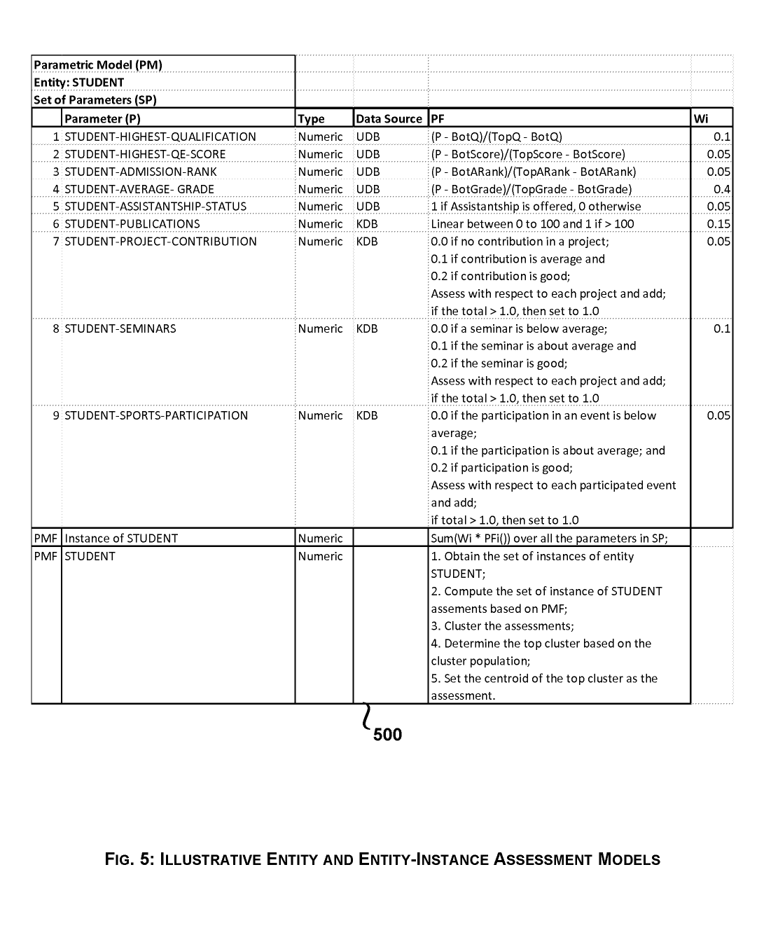

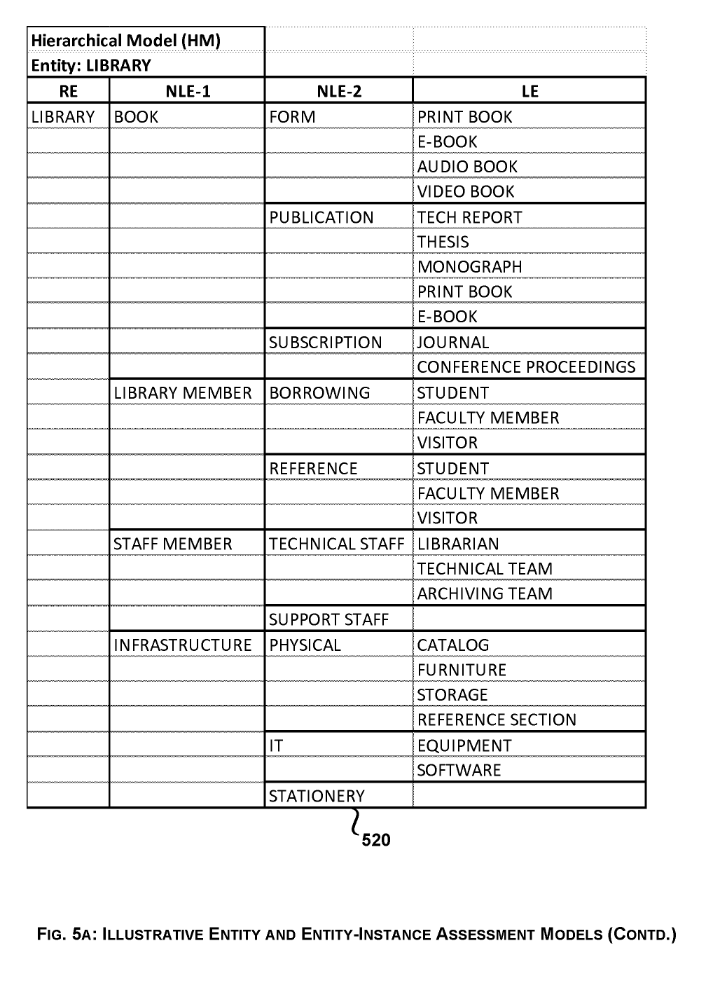

FIG. 5 depicts an illustrative Entity and Entity-Instance Assessment Models. 500 depicts the illustrative parametric model associated with the entity STUDENT. Note that each parameter is associated with a data source that is used to compute the value for the parameter for any entity-instance using the associated parameter function PF. Finally, the parametric model function (PMF) combines these parameter values and in the illustrative model based on the weights associated with each of the parameters.

FIG. 5a depicts additional Illustrative Entity and Entity-Instance Assessment Models. 520 depicts the illustrative hierarchical model related to the entity LIBRARY. Note that LIBRARY is analyzed and decomposed into next level sub-entities: BOOK, LIBRARY MEMBER, STAFF MEMBER, INFRASTRUCTURE. Further, each of these sub-entities are further decomposed as illustrated.

FIG. 5b depicts additional Illustrative Entity and Entity-Instance Assessment Models. 540 depicts an illustrative activity based model related to the entity FACULTY MEMBER. Note that entity is analyzed from the activities point of view and decomposed into activities such as RESEARCH, TEACHES, EXECUTES, EVALUATES, GIVES TALKS, and CO-AUTHORS. Further, each of these activities are further analyzed to build an activity hierarchy as illustrated.

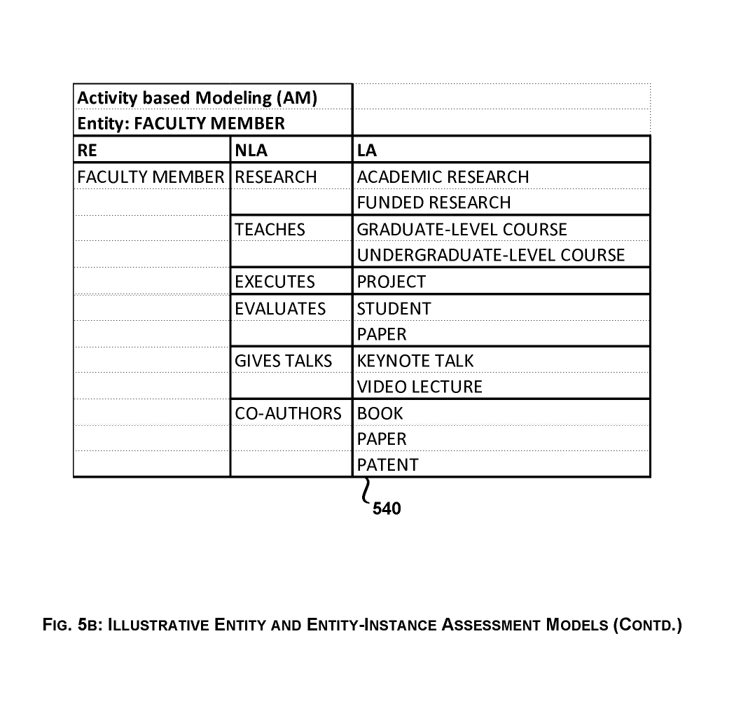

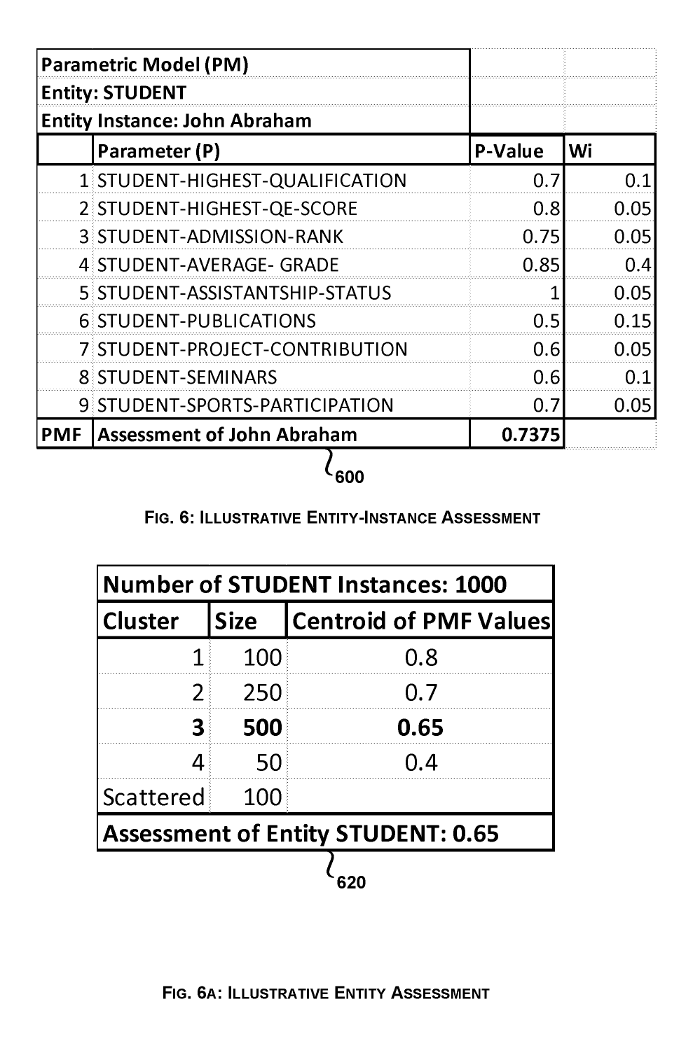

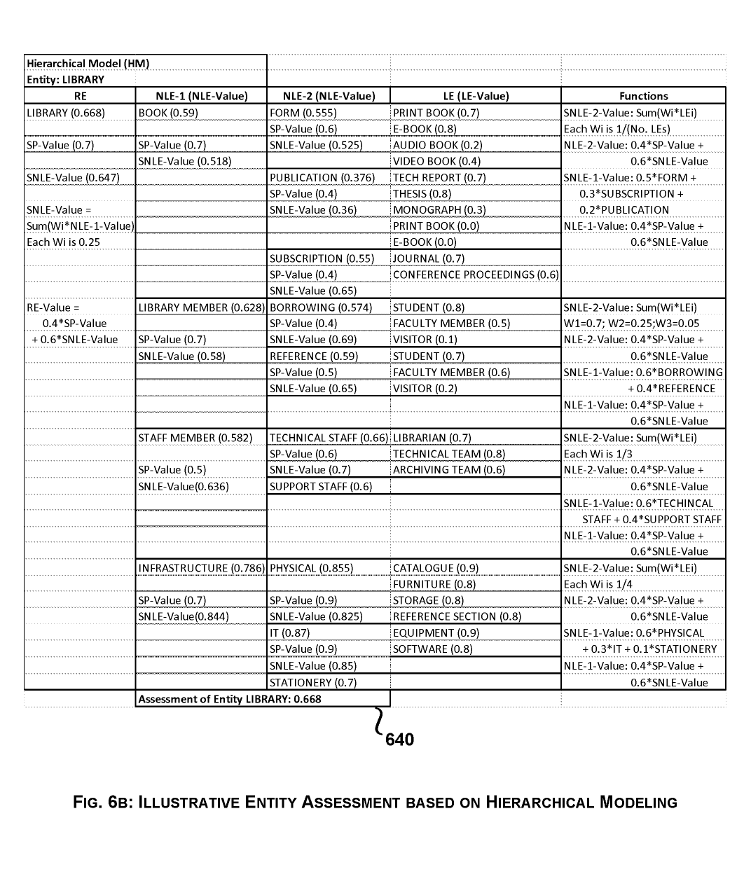

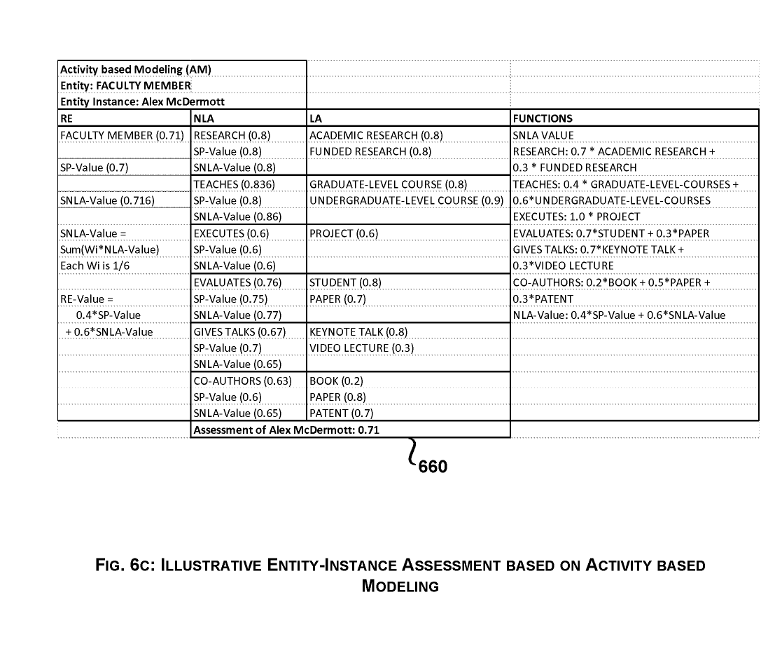

FIG. 6 depicts an illustrative Entity-Instance Assessment. 600 depicts the illustrative assessment of an instance of STUDENT entity, namely, John Abraham. Note that the various parameter values are computed based on the information in UDB and KDB and the final assessments is based on the weights associated with the various parameters.

FIG. 6a depicts an illustrative Entity Assessment. 620 depicts the illustrative assessment of the entity STUDENT. In this assessment, there are 1000 instances of STUDENT and the assessment of these instances are clustered to determine 4 clusters and one scattered cluster (rest of the instances). The cluster centroid is computed for each of the clusters and the entity assessment is based on the centroid of the thickly populated cluster.

FIG. 6b depicts an illustrative Entity Assessment based on Hierarchical Modeling. 640 depicts the illustrative assessment based on hierarchical modeling. The LE values associated with leaf-level entities are derived based on parametric model functions associated with these entities. The NLE-2 values are computed based on the assessment of the leaf-level entities as depicted. For example, SNLE-Value associated with the non-leaf level entity, FORM, is based on the weighted sum of the assessments of its leaf-level entities. Further, each non-leaf entity is also associated with a set of parameters and based UDB and KDB, SP-Value is computed. The NLE-Value associated with FORM is based on SNLE-Value and SP-Value. This process is repeated and finally, the NLE-Value associated with the root entity is the assessment of the entity under consideration.

FIG. 6c depicts an illustrative Entity-Instance Assessment based on Activity based Modeling. 660 depicts the illustrative assessment based on activity modeling. As in the case of hierarchical model based assessment, the assessment of the root entity is based on the assessment of the leaf-level activities and non-leaf level activities.

FIG. 7 describes the aspects of I-Value Computation.

Aspects of and means for obtaining of information for I-Value Computation (700):
1. Consider a pair of entity instances: IEi (of Entity Ei) and Iej (of Entity Ej);
   Iij (710) is the I-Value associated with the influence factor; That is, this indicates the quantification of the influence of Ei on Ej;
2. Factors affecting the I-Value computation:
   (a) Each entity Ei is associated with an assessment: assessments are at two levels: One, at Entity level and the second, at Entity-Instance level;
      These assessments are also called as base scores; These base scores change over a period of time leading to the change in I-Value;
   (b) Consider the set transactions with respect to UDB and KDB over a period of time;
      The co-occurrence of IEi and IEj in the above set of transactions (LCOT) is another factor that affects I-Value computation; and
   (c) The special attributes of IEi and IEj; These attributes are called as I-Params;
3. Double Time Series:
   (a) The Two time series (720 and 730) are related from the point of view of I-Value;
      The top time series (720) depicts the variation in base score or assessment of an entity instance IEi over a period of time;
      The bottom time series (730) depicts the variation in the co-occurrence frequency between say, IEi and another entity instance, IEj;
   (b) For the purposes of analysis, the timeline is divided into multiple segments and these segments could be any unit of interest, say, days, weeks, or months;

FIG. 7a provides additional information about the aspects of I-Value Computation.

Aspects of means for obtaining of information for I-Value Computation (Contd.) (750):
4. In order to formalize further the aspects of I-Value computation, consider IEi influencing the entity instance IEj;
   (a) Positive Influencers (PIs) are defined with respect to a pair of entities, say, Ei and Ej; These PIs form part of a List of Positive Influencers (LoPI);
   (b) Negative Influencers (Nis) are also defined with respect to the pair of entities; These Nis form part of a list of Negative Influencers (LoNI);
   (c) A P-Perspective (PP) with respect to an entity, say, Ei (Ej), defines the extent of impact of positive influence of LoPI on Ei (Ej);
   (d) Similarly, an N-Perspective (NP) with respect to an entity, say, Ei (Ej) defines the extent of impact of negative influence of LoNI on Ei (Ej);
   (e) Generally, a perspective from an entity point of view provides a quantum of positiveness or negativeness;
   (f) Consider a pair of entities: STUDENT and FACULTY MEMBER: Illustrative LoPI: Good grade obtained by STUDENT in a course offered by FACULTY MEMBER; A Good number of technical discussions between STUDENT and FACULTY MEMBER; and STUDENT is in top 10% in FACULTY MEMBER class; Illustrative LoNI: A low grade awarded to STUDENT by FACULTY MEMBER; and A poor attendance record of STUDENT in a class by FACULTY MEMBER;
   (g) Consider PI: A Good Grade by STUDENT in a class by FACULTY MEMBER; STUDENT perspective: 0.7 while FACULTY MEMBER perspective: 0.2; A consistent performance results in a value of 0.6;
   (h) Each PI associated with Ei and Ej has two perspectives: one associated with Ei and another associated with Ej; these two perspectives are a value between 0 and 1;
   (i) Each NI associated with Ei and Ej has two perspectives: one associated with Ei and another associated with Ej; these two perspectives are a value between 0 and 1;

760 summarizes the various aspects: I-Value (770) between a pair of entities Ei and Ej is mutual as depicted by a bi-directional arrow: that is, Ei influences Ej and Ej influences Ei; further, LoPI has two perspectives (PPi and PPj) and similarly, LoNI has two perspectives (PNi and PNj).

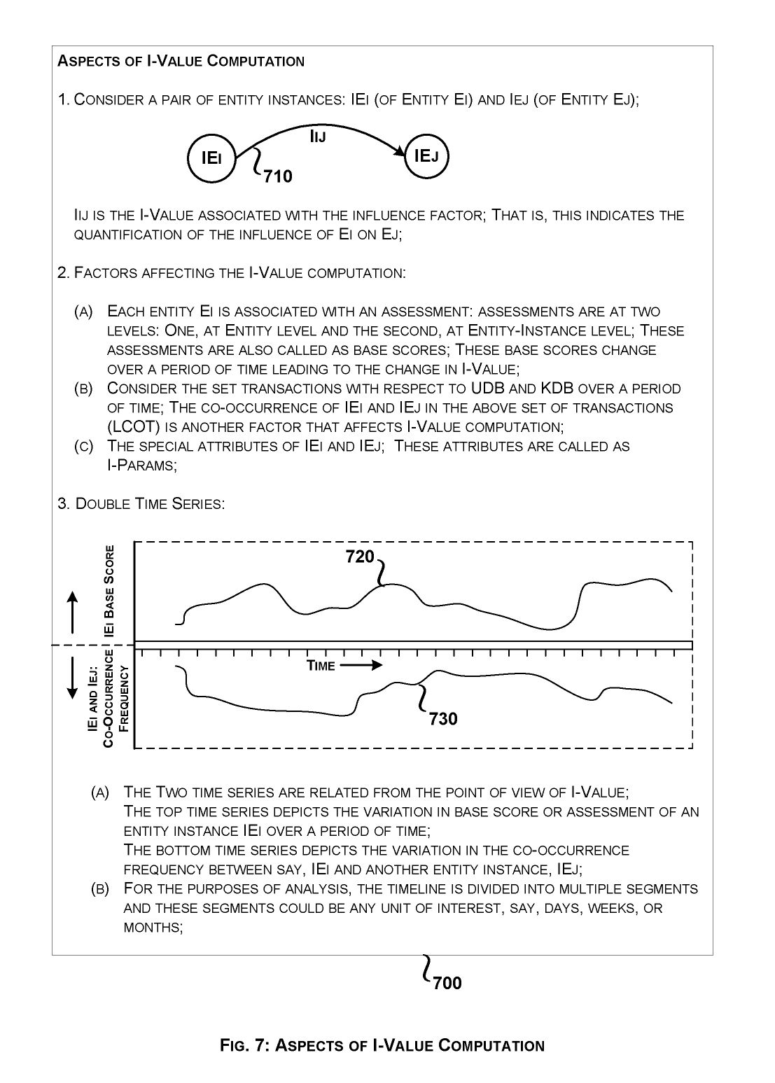

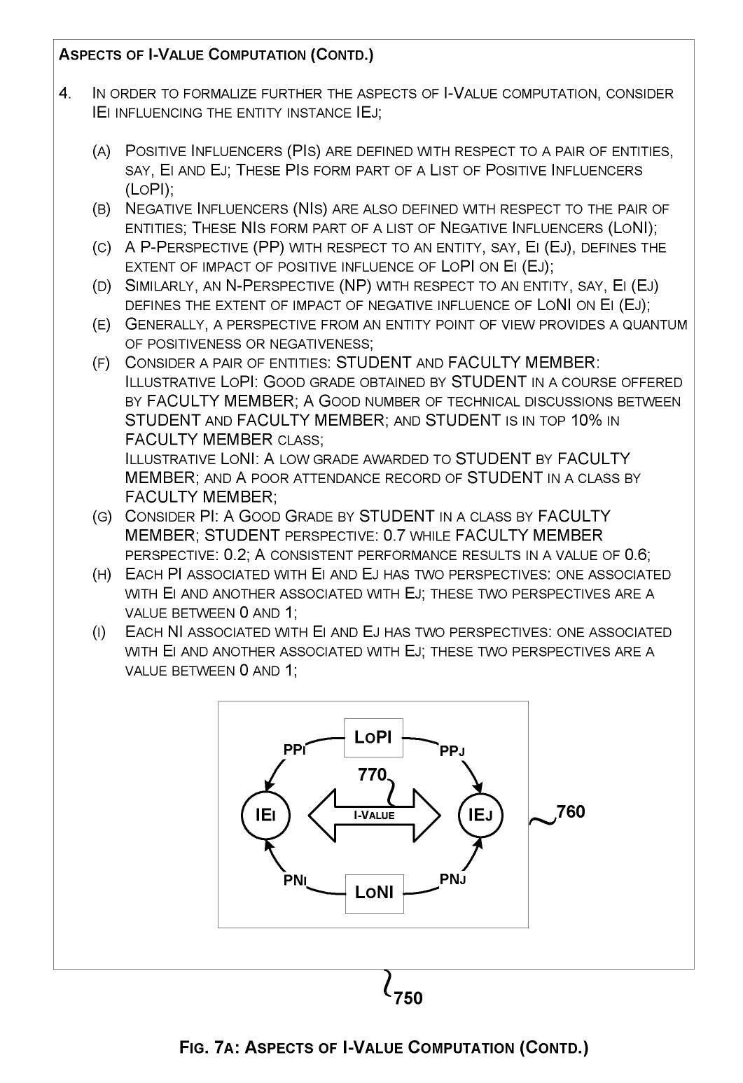

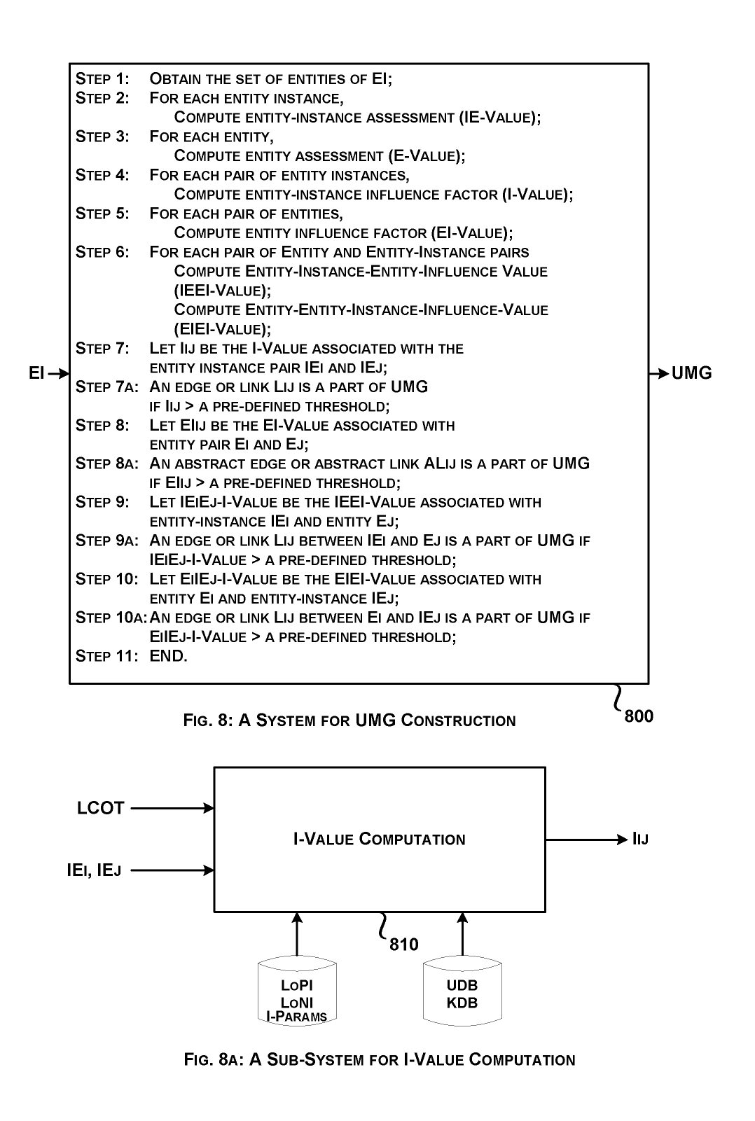

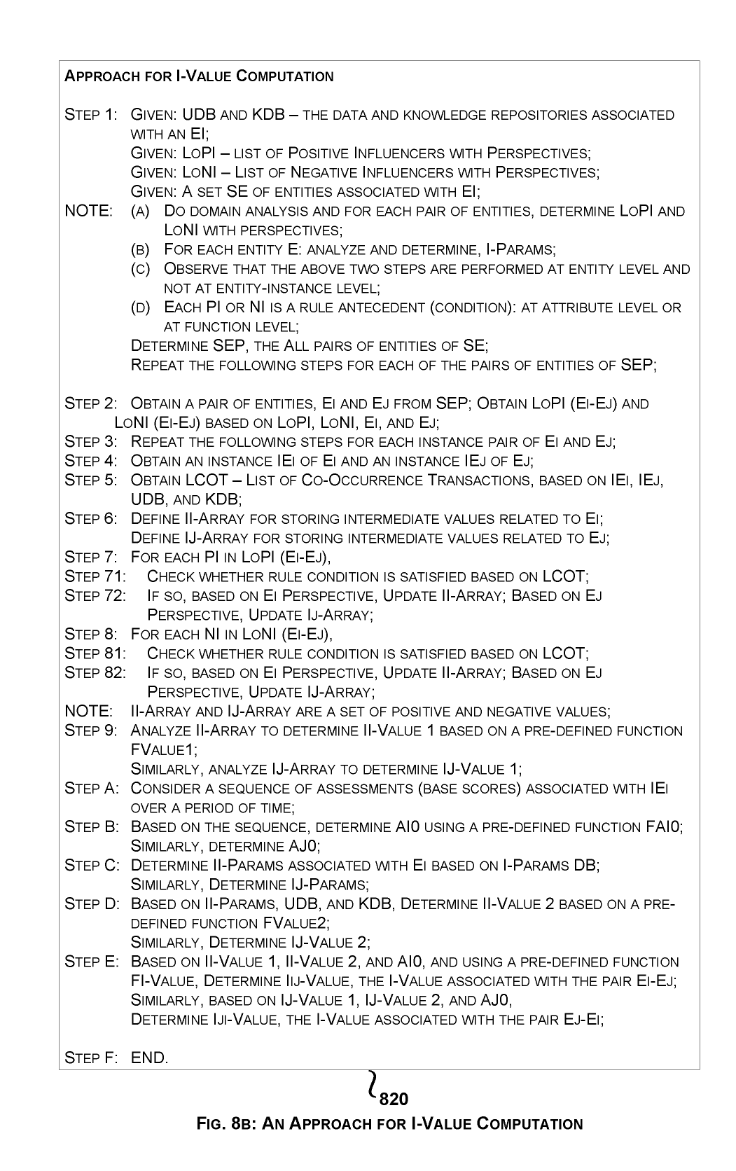

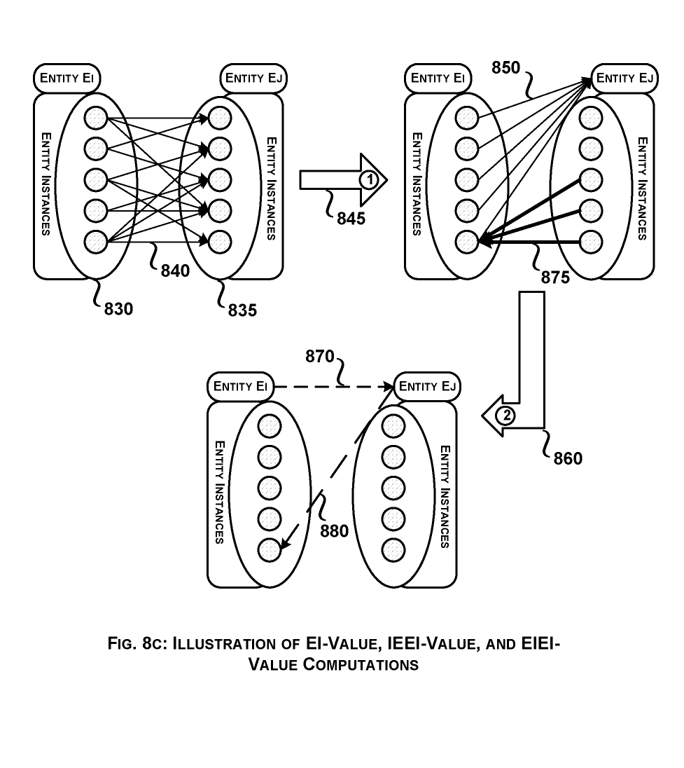

FIG. 8 describes a system for UMG Construction. The overall objective is to construct a University Model Graph for an Educational Institution EI (800) and the means for the construction of the university model graph are as follows.

Step 1: Obtain the set of entities of EI;

Step 2: For each entity instance,
Compute entity-instance assessment (IE-Value);

Step 3: For each entity,
Compute entity assessment (E-Value);

Step 4: For each pair of entity instances,
Compute entity-instance influence factor (I-Value);

Step 5: For each pair of entities,
Compute entity influence factor (EI-Value);

Step 6: For each pair of Entity and Entity-Instance pairs
Compute Entity-Instance-Entity-Influence Value (IEEI-Value);
Compute Entity-Entity-Instance-Influence-Value (EIEI-Value);

Step 7: Let Iij be the I-Value associated with the entity instance pair IEi and IEj;

Step 7a: An edge or link Lij is a part of UMG if Iij>a pre-defined threshold;

Step 8: Let EIij be the EI-Value associated with entity pair Ei and Ej;

Step 8a: An abstract edge or abstract link ALij is a part of UMG if EIij>a pre-defined threshold;

Step 9: Let IEiEj-I-Value be the IEEI-Value associated with entity-instance IEi and entity Ej;

Step 9a: An edge or link Lij between IEi and Ej is a part of UMG
if IEiEj-I-Value>a pre-defined threshold;

Step 10: Let EiIEj-I-Value be the EIEI-Value associated with entity Ei and entity-instance IEj;

Step 10a: An edge or link Lij between Ei and IEj is a part of UMG
if EiIEj-I-Value>a pre-defined threshold;

Step 11: END.

FIG. 8a describes a sub-system for I-Value Computation.

I-Value computation is for a pair of entity instances (IEi and IED and uses the databases related to UDB, KDB, LoPI, and LoNI along with LCOT to compute Iij (810).

FIG. 8b describes an approach for I-Value Computation.

Means and Approach for I-Value Computation (820):
Step 1:
   Given: UDB and KDB—the data and knowledge repositories associated with an EI;
   Given: LoPI—list of Positive Influencers with Perspectives;
   Given: LoNI—List of Negative Influencers with Perspectives;
   Given: A set SE of entities associated with EI;
   NOTE: (a) Do domain analysis and for each pair of entities, determine LoPI and LoNI with perspectives;
   (b) For each entity E: analyze and determine, I-Params;
   (c) Observe that the above two steps are performed at entity level and not at entity-instance level;
   (d) Each PI or NI is a rule antecedent (condition): at attribute level or at function level;
   Determine SEP, the All pairs of entities of SE;
   Repeat the following steps for each of the pairs of entities of SEP;
Step 2: Obtain a pair of entities, Ei and Ej from SEP; Obtain LoPI (Ei-Ej) and
   LoNI (Ei-Ej) based on LoPI, LoNI, Ei, and Ej;
Step 3: Repeat the following steps for each instance pair of Ei and Ej;
Step 4: Obtain an instance IEi of Ei and an instance IEj of Ej;
Step 5: Obtain LCOT—List of Co-Occurrence Transactions, based on IEi, IEj, UDB, and KDB;
Step 6: Define II-Array for storing intermediate values related to Ei;
   Define IJ-Array for storing intermediate values related to Ej;
Step 7: For each PI in LoPI (Ei-Ej),
Step 71: Check whether rule condition is satisfied based on LCOT;
Step 72: If so, based on Ei Perspective, Update II-Array;
   Based on Ej, Perspective, Update Ij-Array;
Step 8: For each NI in LoNI (Ei-Ej),
Step 81: Check whether rule condition is satisfied based on LCOT;
Step 82: If so, based on Ei Perspective, Update II-Array;
   Based on Ej, Perspective, Update IJ-Array;

NOTE: II-Array (also referred as a plurality of pn values) and IJ-Array are a set of positive and negative values;
Step 9: Analyze II-Array to determine II-Value 1 (also referred as an influence component 1) based on a pre-defined function FValue1;
   Similarly, analyze IJ-Array to determine IJ-Value 1;
Step A: Consider a sequence of assessments (base scores) associated with IEi over a period of time;
Step B: Based on the sequence, determine AI0 (also referred as an influence component 2) using a pre-defined function FAI0;
   Similarly, determine AJ0;
Step C: Determine II-Params (also referred as a plurality of influencing parameters) associated with Ei based on I-Params DB;
   Similarly, Determine IJ-Params;
   Step D: Based on II-Params, UDB, and KDB, Determine II-Value 2 (also referred as an influence component 3) based on a pre-defined function FValue2;
   Similarly, Determine IJ-Value 2;
Step E: Based on II-Value 1, II-Value 2, and AI0, and using a pre-defined function FI-Value, Determine Iij-Value, the I-Value associated with the pair Ei-Ej;
   Similarly, based on IJ-Value 1, IJ-Value 2, and AJ0,
   Determine Iji-Value, the I-Value associated with the pair Ej-Ei;
Step F: END.

FIG. 8c provides an illustration of EI-Value, IEEI-Value, and EIEI-Value Computations. Consider two entities Ei and Ej; 830 describes the instances of Ei and 835 describes the instances of Ej; and the EI-Value is related to the influence of the entity Ei upon the entity Ej. This computation is based on the I-Values associated with the directed edge connecting 830 and 835 (840). Consider an instance of Ei; this influences multiple instances of Ej as depicted. The first step (845) is to reduce the I-Value associated with these multiple instances into a single value (850). At this stage, the computed single influence value is associated with the entity Ej as depicted. Note that this computed single influence value depicts the computation of IEEI-Value. This is repeated for each of the instances of Ei. Observe that multiple single values get associated with Ej. The next step (860) is to reduce these multiple single values to the EI-Value associated with the abstract link between Ei and Ej (870). In order to compute EIEI-Value, consider the multiple instances of Ej that influence an instance IEi of Ei (875). Reducing of the I-Vaues associated with these multiple instances into a single value results in the computation of EIEI-Value (880).

FIG. 8d depicts an approach for EI-Value, IEEI-Value, and EIEI-Value Computations. Means and Approach for EI-Value, IEEI-Value, and EIEI-Value Computations (880):
Step 1: Given: A set SE of entities associated with EI;
   Determine SEP, the All pairs of entities of SE;
   Repeat the following steps for each of the pairs of entities of SEP;
Step 2: Obtain a pair of entities, Ei and Ej from SEP;
Step 3: Let SIEi be the set of instance of Ei;
   Similarly, let SIEj be the set of instances of Ej;
Step 4: For each IEi of SIEi,
Step 41: Let Sj be the set of instances of Ej influenced by IEi;
Step 42: Determine ISj based on I-Value associated with each of Sj;
Note: ISj is a sequence of positive and negative values between −1 and 1;
Step 43: Let PIS be the set of positive values based on ISj;
   Similarly, let NIS be the set of negative values based on ISj;
Step 44: Compute clusters CPI of elements of PIS based on a pre-defined threshold;
   Similarly, compute clusters CNI of elements of NIS based on a pre-defined threshold;
Step 45: Select clusters of CPI into SCPI such that the population of each cluster of SCPI>a pre-defined threshold;
   Similarly, Select clusters of CNI into SCNI such that the population of each cluster of SCNI>a pre-defined threshold;
Step 46: Determine total population size PI based on SCPI and SCNI;
Step 47: Select top clusters of SCPI into SPI such that the combined population size>a pre-defined threshold based on PI;
   Similarly, select top clusters of SCNI into SNI such that the combined population size>a pre-defined threshold based on PI;
Step 48: Determine the centroid PCi of each cluster of SPI based on the population of the ith cluster of SPI;
Step 49: Similarly, determine the centroid NCi of each cluster of SNI based on the population of the ith cluster of SNI;
Step 4a: Compute the set of weights associated with the clusters of SPI and SNI based on the population of the clusters;
Step 4b: Compute IiEiEj-Value, the influence of the instance IEi of Ei on Ej based on the set of positive centroid values, the set of negative centroid values, and the corresponding weights;
Step 4c: IEiEj-I-Value forms the basis for the computation of IEEI-Value between IEi and Ej;
Step 4d: Determine the set of instances Sj1 of Ej that influence Ei;
Step 4e: Determine ISj1 based on I-Value associated with each of Sj1;
Note: ISj1 is a sequence of positive and negative values between −1 and 1;
Step 4f: Repeat Step 41 through 4b with respect to ISj1-Value to determine
   EIEI-Value between Ej and IEi;
Step 4g: Make IEiEj-I-Value a part of SEj-Value;
Note: SEj-Value is a set of positive and negative numbers between −1 and 1;
Step 5: Repeat Step 41 through 4b with respect to SEj-Value to determine Eiji-Value;
Step 6: END.

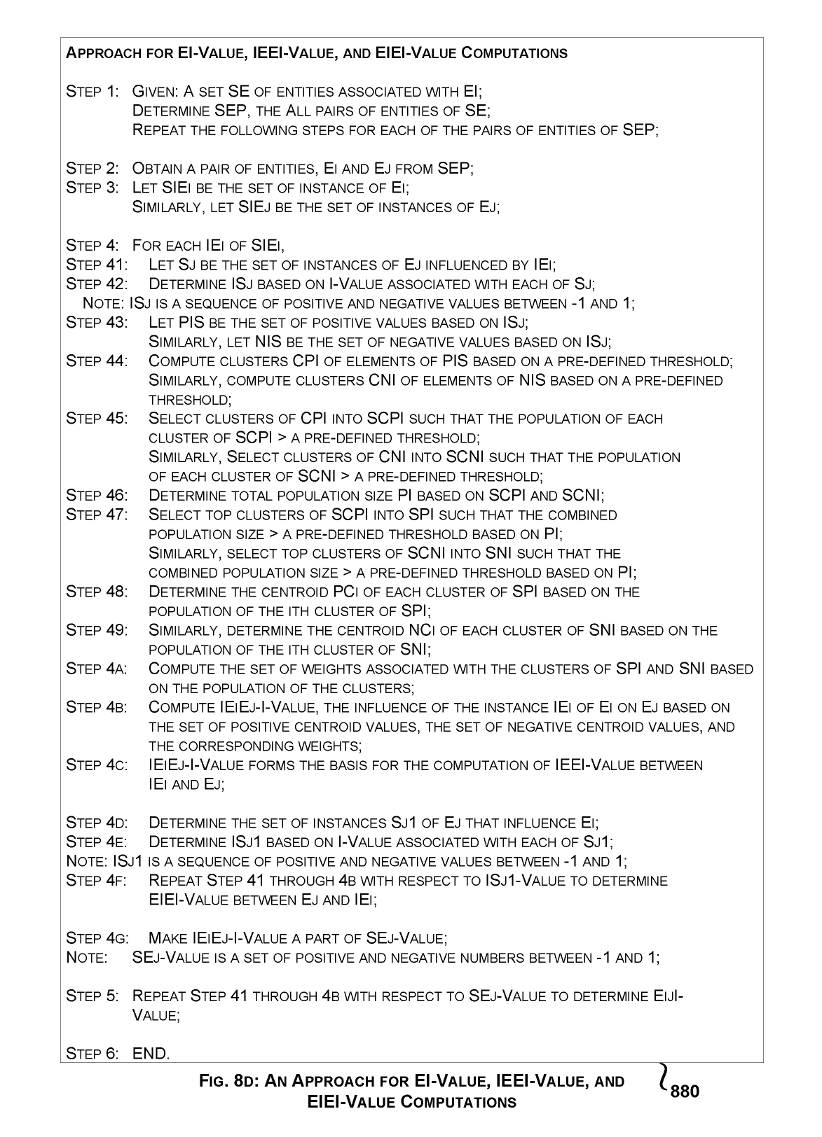

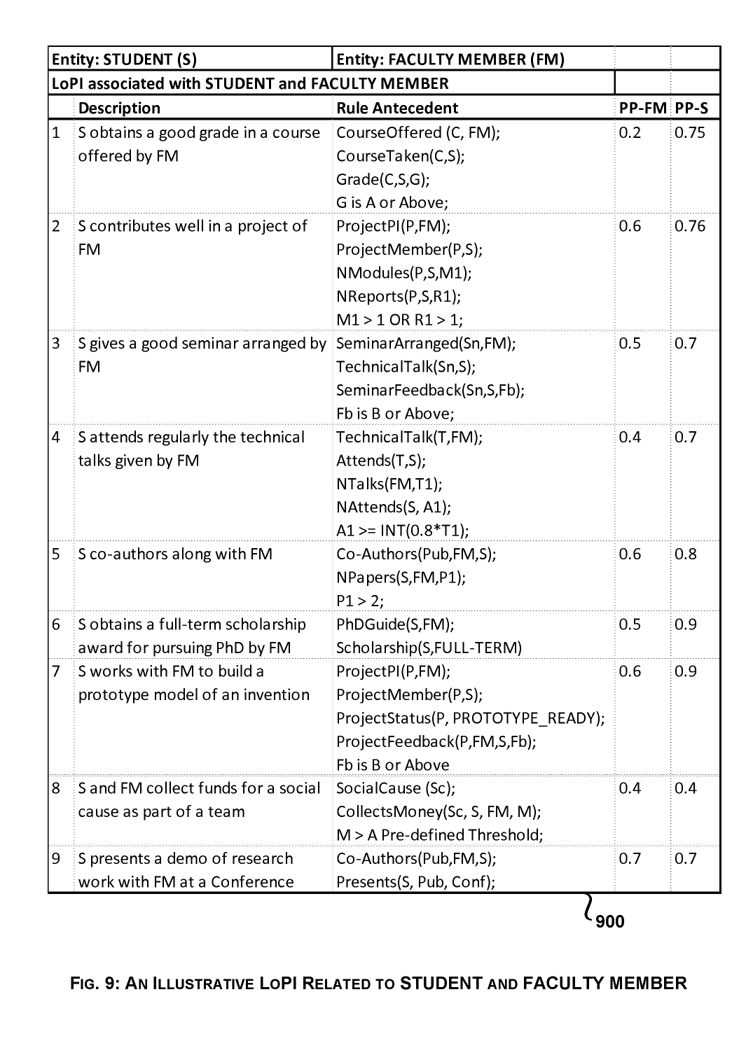

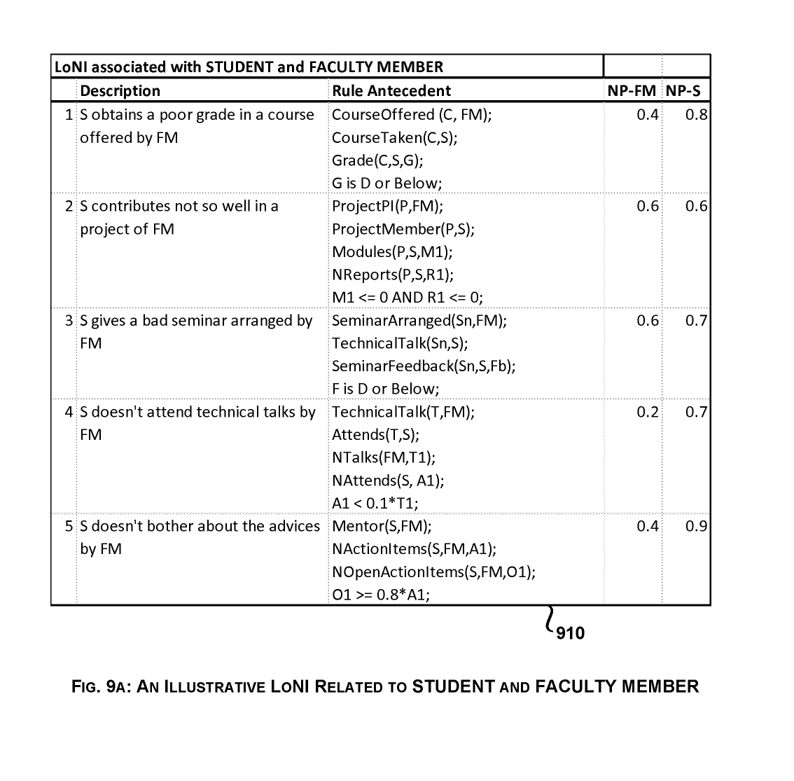

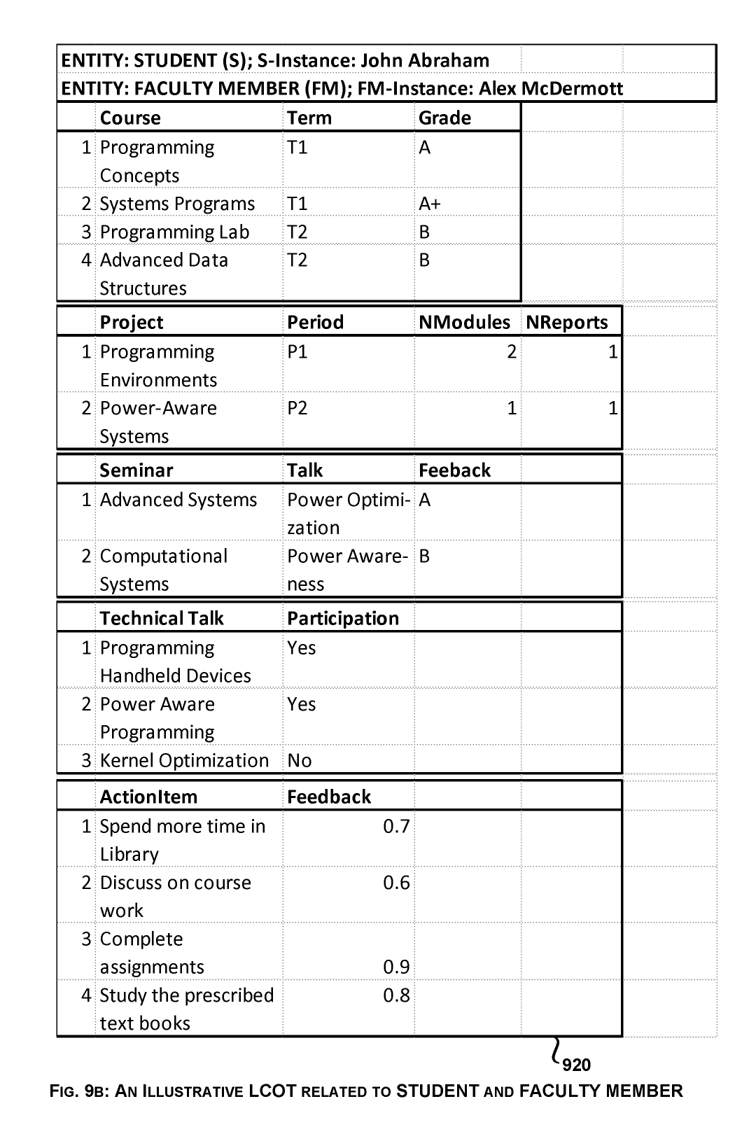

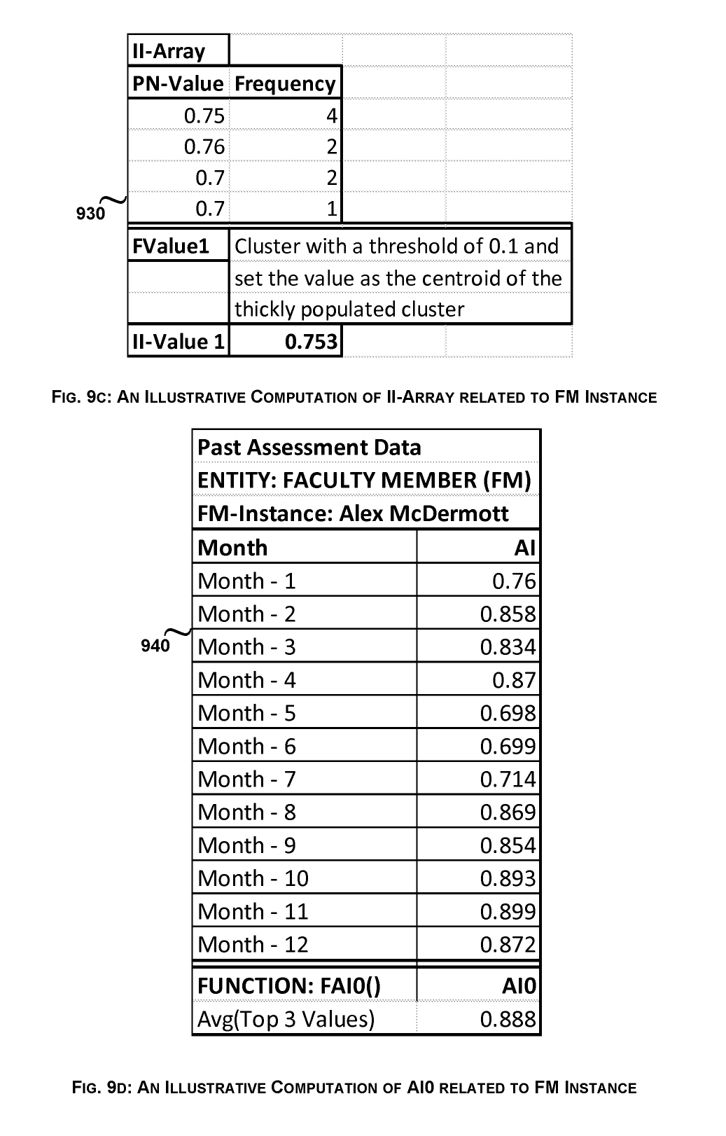

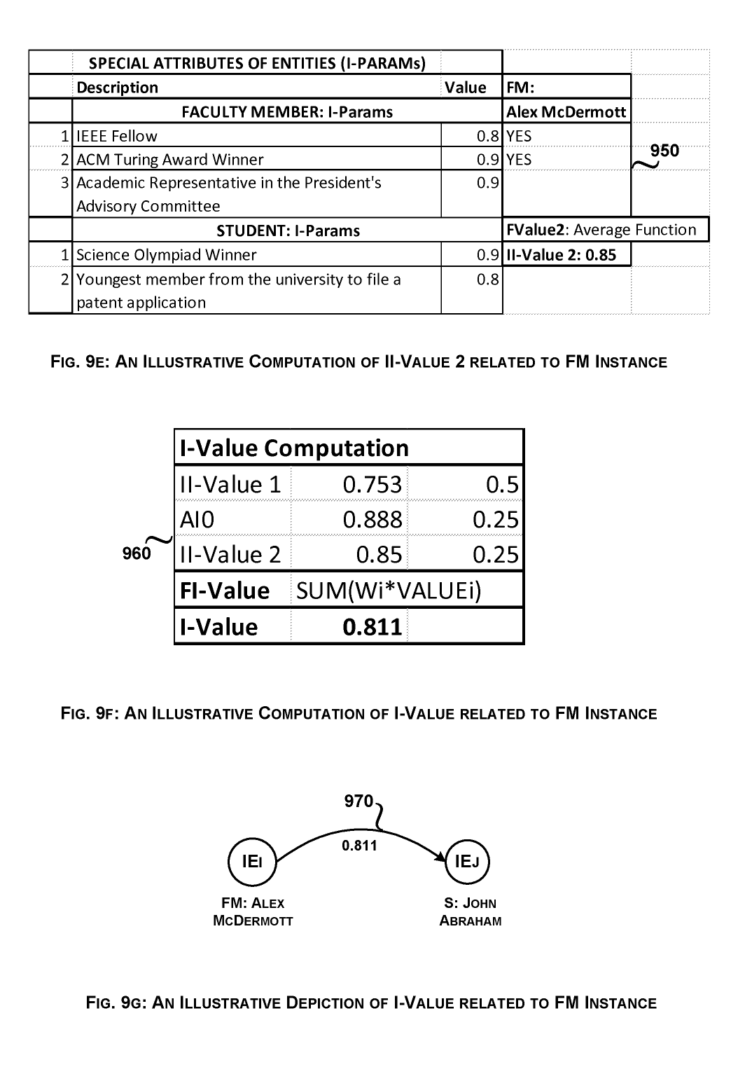

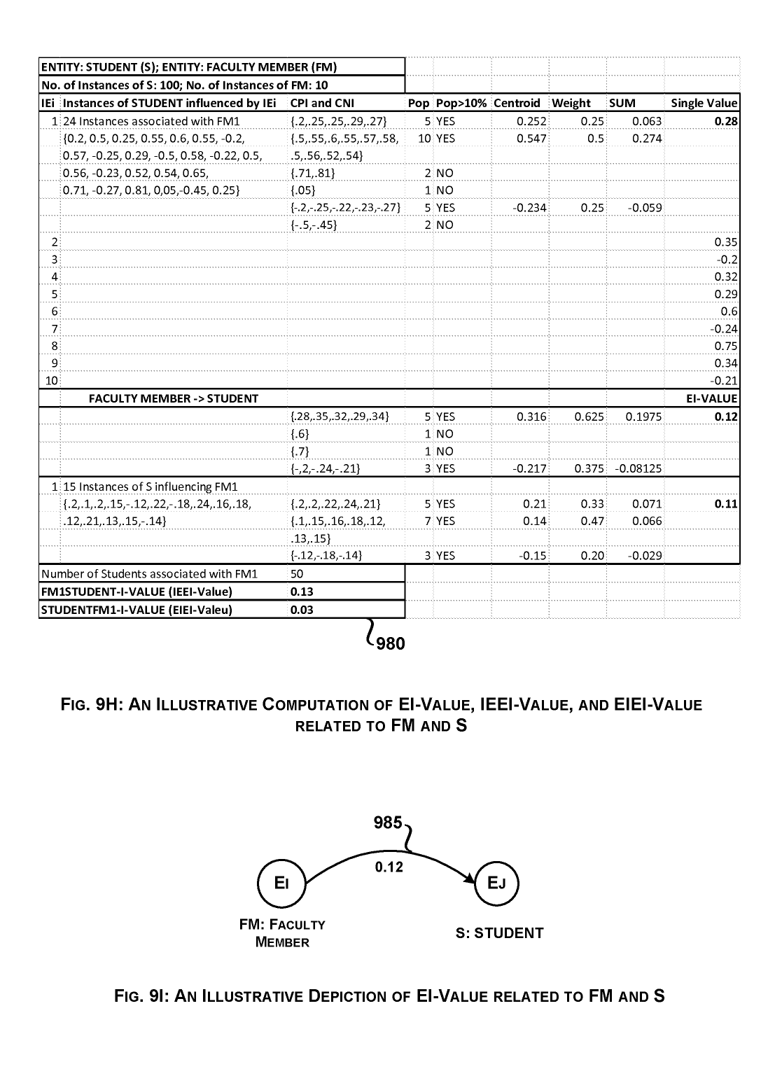

FIG. 9 provides an illustrative LoPI related to STUDENT and FACULTY MEMBER. 900 depicts an illustrative LoPI. Two entities under consideration are STUDENT and FACULTY MEMBER. Consider a positive influencer “a student obtains a good grade in a course offered by a faculty member”: the rule antecedent clearly defines how to determine whether this influencer is satisfied by a particular instantiated value for STUDENT and FACULTY MEMBER; Further, the perspectives from STUDENT and FACULTY MEMBER point of view are also depicted.

FIG. 9a provides an illustrative LoNI related to STUDENT and FACULTY MEMBER. As in the case of LoPI, 910 depicts a few illustrative negative influencers.

FIG. 9b provides an illustrative LCOT related to STUDENT and FACULTY MEMBER. The list of co-occurrence transactions related to a pair of entity instances related to STUDENT entity (instance John Abraham) and FACULTY MEMBER entity (instance Alex McDermott) is depicted in 920. The data depicted is used in assessing the relevance of LoPI and LoNI for the entity instance pair under consideration.

FIG. 9c provides an illustrative computation of II-Array related to FM Instance. 930 depicts the computational results: II-Array indicates how the various influencers in LoPI and LoNI got evaluated with respect to LCOT. This is a sequence of positive and negative values (between 0 and 1) as indicated in 930 and illustrative pre-defined function FValue1 is to cluster the sequence and obtaining the centroid of the thickly populated cluster and II-Value1 is set with this centroid value.

FIG. 9d provides an illustrative computation of AI0 related to FM Instance. 940 depicts the time series related to the assessment (base score) of the entity instance under consideration over the last twelve months. The illustrative pre-defined function FAI0 is compute the average of the top three peak values of the time series.

FIG. 9e provides an illustrative computation of II-Value 2 related to FM Instance. 950 depicts the illustrative I-Params related to the STUDENT entity and FACULTY MEMBER entity. Also depicted is the assessment of the I-Params with respect to an instance of FACULTY MEMBER Alex McDermott. II-Value2 computation is based on the pre-defined function (illustrated is the Average Function) and the I-Params assessments.

FIG. 9f provides an illustrative computation of I-Value related to FM Instance. 960 depicts the computation of I-Value based on II-Value1, AI0, and II-Value 2 using a pre-defined function (illustrated is the Weighted Sum).

FIG. 9g provides an illustrative depiction of I-Value related to FM Instance. Note that I-Value is the weight associated with a link connecting two entity instances (970). Illustrated is the nature and quantum of influence by the faculty member Alex McDermott on the student John Abraham.

FIG. 9h provides an illustrative computation of EI-Value, EI-Value, IEEI-Value, and EIEI-Value related to FM and S. 980 depicts illustrative instances of FACULTY MEMBER (about ten instances) and shows the instances of the entity STUDENT influenced by FM 1 (about twenty four of them). The figure also indicates the intermediate values leading to the computation of IEiEj-I-Value 0.28 (Single Value).

Note that this forms the basis for the computation of IEEI-Value 0.13 between FM1 and S. The multiple single values with respect to the various of FACULTY MEMBER instances are analyzed to arrive at EI-Value (0.12). In order to compute EIEI-Value between STUDENT and FM1, fifteen instances of S influencing FM1 are considered. The resulting single value 0.11 forms the basis for the computation of EIEI-Value of 0.03 between STUDENT and FM1.

FIG. 9i provides an illustrative depiction of EI-Value related to FM and S. 985 indicates the influence factor of 0.12 associated with an abstract directed link from the entity FACULTY MEMBER to the entity STUDENT.

FIG. 9J provides the summary of Four Influence Values related to FM and S. Observe that 990 depicts EI-Value of 0.12 between FM and S, 992 depicts the EIEI-Value of 0.03 between S and FM1, and 994 depicts the IEEI-Value of 0.13 between FM1 and S. Finally, 996 depicts the I-Value of 0.811 between FM1 and S2.

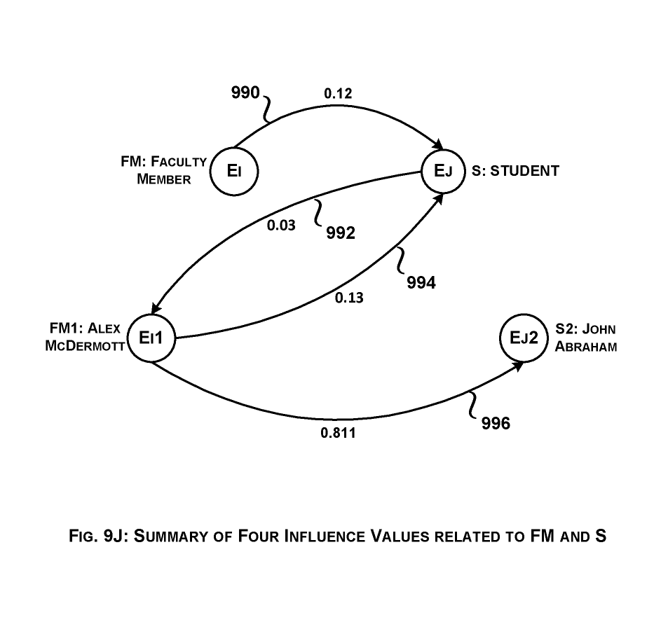

FIG. 10 provides an illustrative elaboration (1000) of University Modeling System. In a preferred embodiment, the University Modeling System (1020) is realized on a computer system (1005) with several processors, primary memory units, secondary memory units, and network interfaces, and with an operating system (1010) and a database system (1015). The database system in particular comprises of a component University Model Graph (UMG) DB Interface (1025) to help access University Model Graph (UMG) database (1030). As depicted in the figure, the University Modeling System comprises of two key components, namely, Model Construction (1035) and Transaction Analysis (1040). The Model Construction component is responsible for the construction of a university model graph associated with a university. More specifically, as an example, consider the University Model Graph predominantly modeling students: in this case, the nodes of the university model graph comprises of student assessments and directed edges denote the influence of students over other students. The Model Construction component helps compute both student assessments and student influence values. This component is assisted by the Transaction Analysis component that analyzes the student related transactions contained in UMG database and extracts the relevant information (as elaborated subsequently) for the model construction purposes.

The IP Network Interface (1050) is used to connect the computer system to an Internet Protocol (IP) Network (1055) so that several users (1060) can connect and interact with the University Assessment System through the Internet or an intranet.

Please note that, from the perspective of a set of students of a university, a structural representation of the university in the form of a university model graph is constructed by computing a set of assessments of the set of students and computing a set of influence values, and this set of influence values further comprises of a set of positive influence values between any pair of students, and a set of negative influence values between any pair of students of the university.

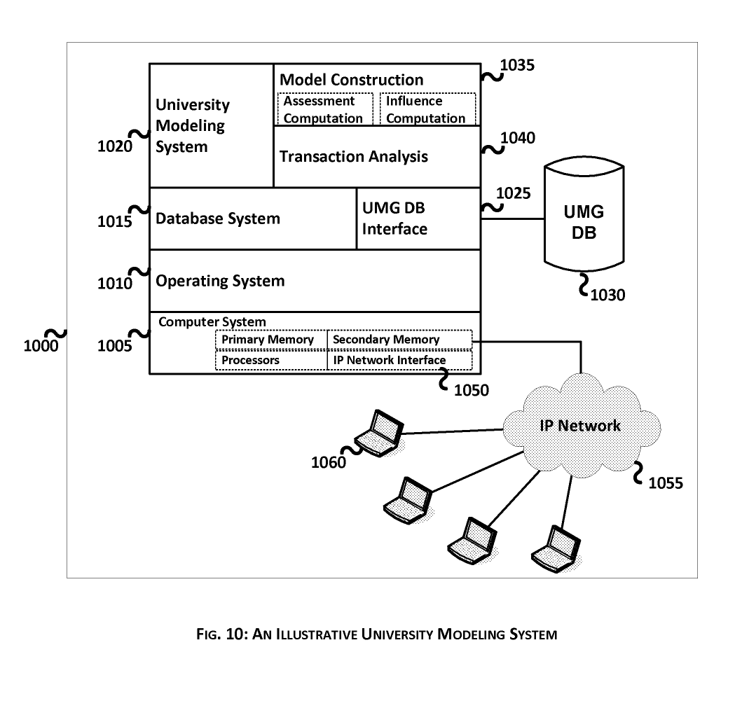

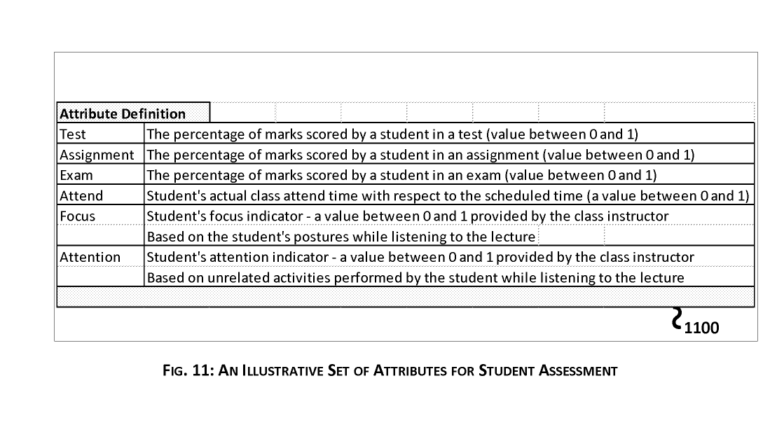

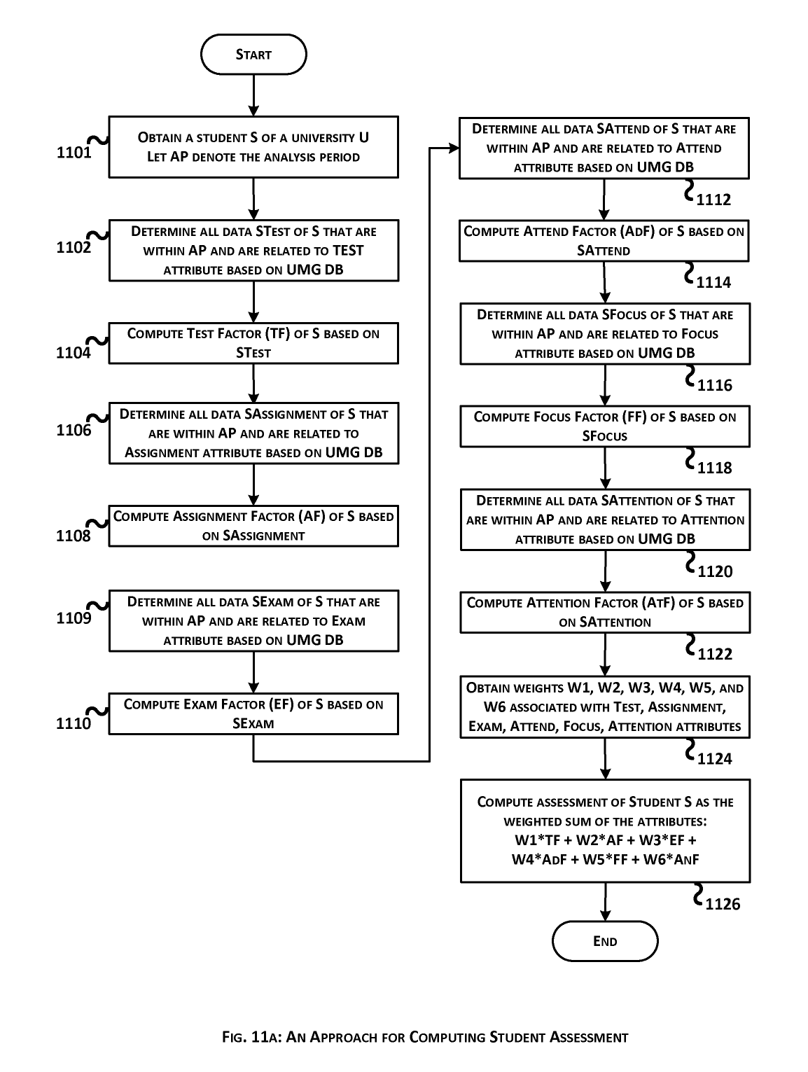

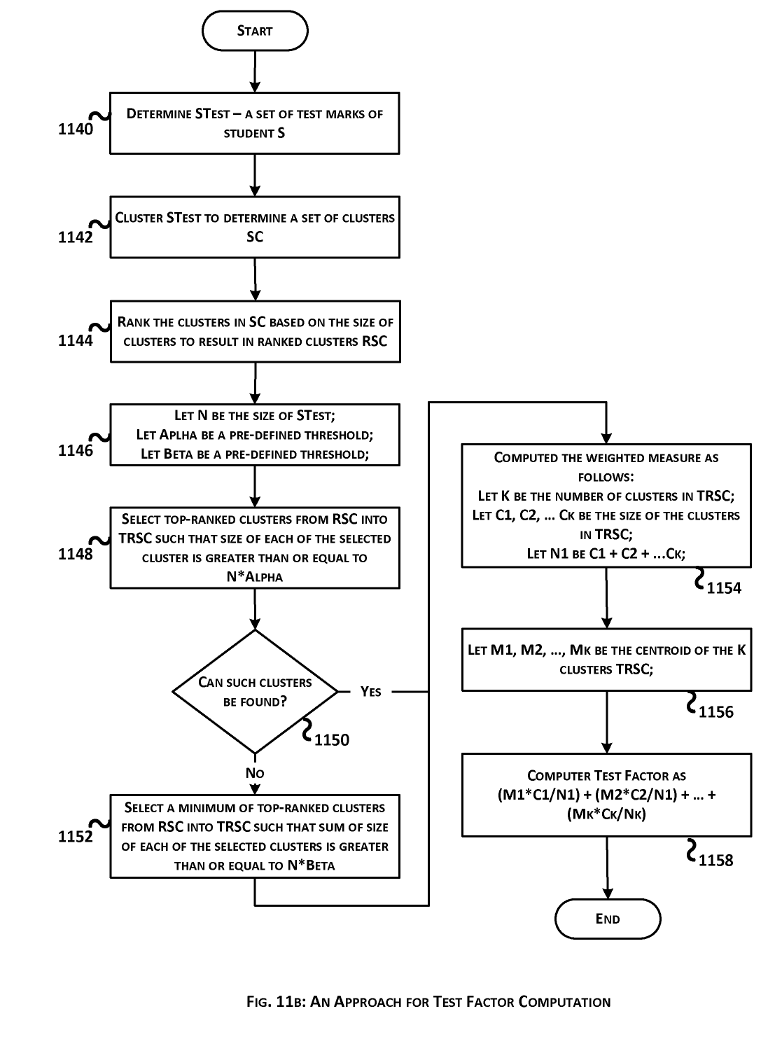

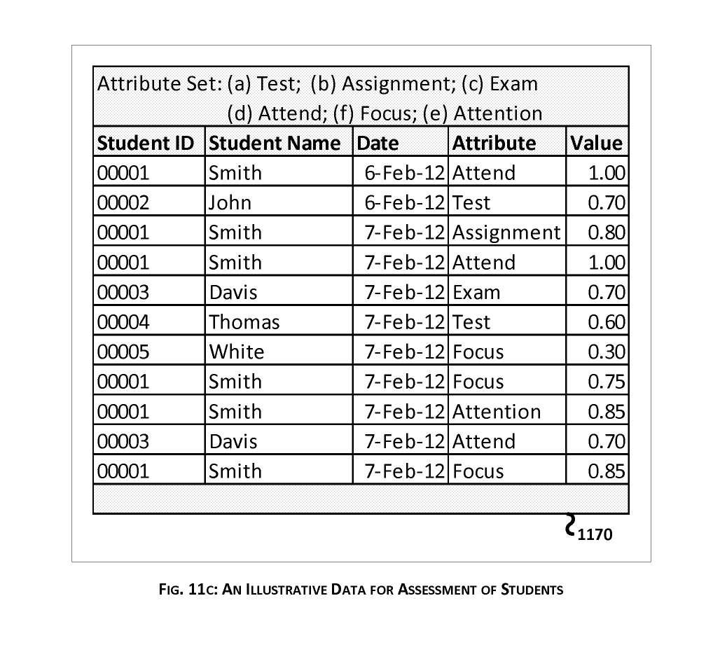

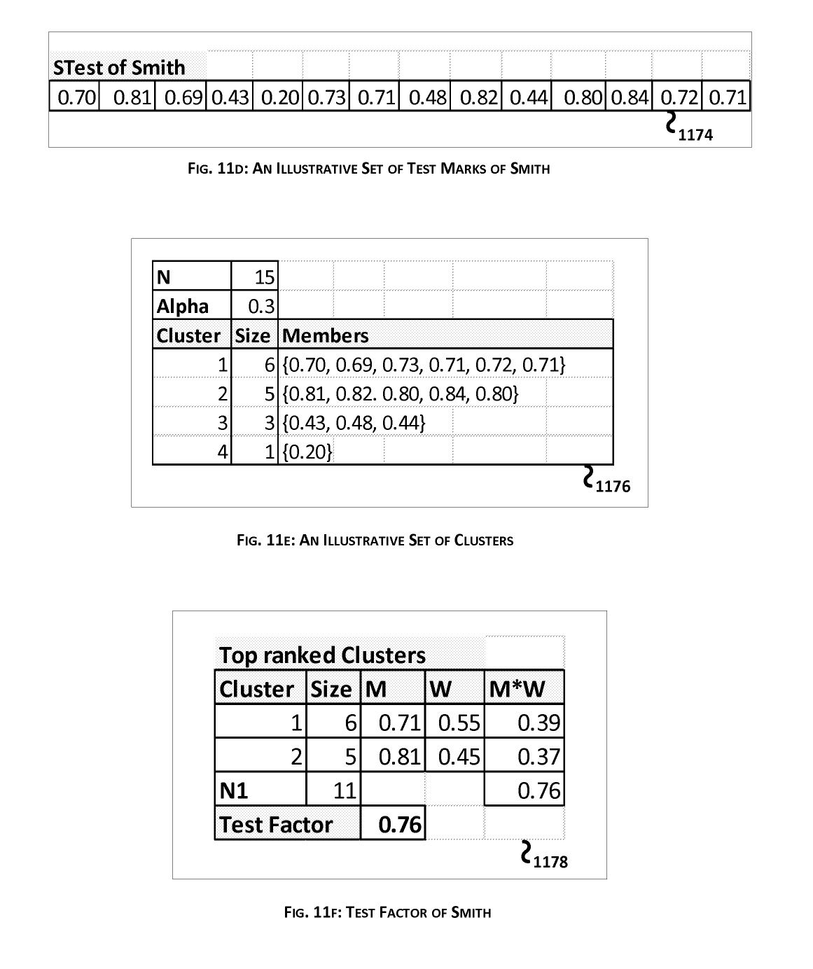

FIG. 11 provides an illustrative set of attributes for Student assessment. The student assessment is based on a set of attributes (1100) and in particular, the set comprises of the following attributes: Test, Assignment, Exam, Attend, Focus, and Attention. These attributes are further described below. Test Attribute The percentage of marks scored by a student in a test (value between 0 and 1); this attribute captures the marks scored by the student in various tests.

Assignment Attribute The percentage of marks scored by a student in an assignment (value between 0 and 1); this attribute captures the marks scored by the student in various assignments.

Exam Attribute The percentage of marks scored by a student in an exam (value between 0 and 1); this attribute captures the marks scored by the student in the various exams.

Attend Attribute: Student's actual class attend time with respect to the scheduled time and is a value between 0 and 1; this attribute captures the regularity of the student in attending the classes.

Focus Attribute Student's focus indicator—a value between 0 and 1 provided by the class instructor; this attribute captures how focused the student had been while in the class; it is determined based on the student's postures while listening to the lecture.

Attention Attribute: Student's attention indicator—a value between 0 and 1 provided by the class instructor; this attribute capture how attentive the student had been while in the class; it is determined based on unrelated activities performed by the student while listening to the lecture.

FIG. 11A provides an approach for computing student assessment.

The student assessment computation is based on the data in the UMG database over an Analysis Period (AP). In particular, the various attribute data records such as those related to test attribute, assignment attribute, exam attribute, attend attribute, focus attribute, and attention attribute that are within AP window are extracted from the UMG database for assessment purposes.

Obtain a student S of a university U (1101); Let AP denote the analysis period.

Determine all data STest of S that are within AP and are related to Test attribute based on UMG DB (1102).

Compute Test Factor (TF) of S based on STest (1104).

Determine all data SAssignment of S that are within AP and are related to Assignment attribute based on UMG DB (1106).

Compute Assignment Factor (AF) of S based on SAssignment (1108).

Determine all data SExam of S that are within AP and are related to Exam attribute based on UMG DB (1109).

Compute Exam Factor (EF) of S based on SExam (1110).

Determine all data SAttend of S that are within AP and are related to Attend attribute based on UMG DB (1112).

Compute Attend Factor (AdF) of S based on SAttend (1114).

Determine all data SFocus of S that are within AP and are related to Focus attribute based on UMG DB (1116).

Compute Focus Factor (FF) of S based on SFocus (1118).

Determine all data SAttention of S that are within AP and are related to Attention attribute based on UMG DB (1120).

Compute Attention Factor (AnF) of S based on SAttention (1122).

Obtain weights W1, W2, W3, W4, W5, and W6 associated with Test, Assignment, Exam, Attend, Focus, Attention attributes (1124).

Compute assessment of Student S as the weighted sum of the attributes (1126):

W1*TF+W2*AF+W3*EF+W4*AdF+W5*FF+W6*AnF and this computed assessment is made part of the set of assessments.

FIG. 11B provides an approach for Test Factor computation.

As described in FIG. 11A, the student assessment involves the computation of various factors such as Test Factor, Assignment Factor, Exam Factor, Attend Factor, Focus Factor, and Attention Factor. Each of these factors is computed based on a set of data associated with the corresponding attribute. In the following, an approach for computing one of the factors, say Test Factor, is elaborated.

Determine STest—a set of test marks of student S (1140). Note that this set is over a particular analysis period AP.

Cluster STest to determine a set of clusters SC (1142). This step helps in computing a better value for Test Factor as, typically, the test marks can be widely distributed across the range.

Rank the clusters in SC based on the size of clusters to result in ranked clusters RSC (1144). The objective of this step is to eliminate the so called the outliers.

Let N be the size of STest (1146); Let Aplha be a pre-defined threshold; and let Beta be another pre-defined threshold. These thresholds are used to select the appropriate clusters for computing Test Factor.

Select top-ranked clusters from RSC into TRSC such that size of each of the selected cluster is greater than or equal to N*Alpha (1148).

Check whether such clusters can be found (1150).

If it is not so, select a minimum of top-ranked clusters from RSC into TRSC such that sum of size of each of the selected clusters is greater than or equal to N*Beta (1152). This is the case when the test marks in STest are widely distributed and hence, there are no dominating clusters.

Based on the clusters in TRSC, the weighted measure is computed as follows (1154):

Let K be the number of clusters in TRSC;

Let C1, C2, . . . Ck be the size of the clusters in TRSC; and

Let N1 be C1+C2+ . . . Ck.

Let M1, M2, . . . , Mk be the centroid of the K clusters in TRSC (1156).

Computer Test Factor as (M1*C1/N1)+(M2*C2/N1)+ . . . +(Mk*Ck/Nk) (1158).

FIG. 11C depicts an illustrative data for assessment of students.

The data for assessment of students is contained in UMG database and in particular, comprises of values for the various of the attributes such as Test, Assignment, Exam, Attend, Focus, and Attention (1170).

Note that, for example, the values of the set STest is generated based on such data.

FIG. 11D provides illustrative test marks of a student.

For example, STest for a particular student Smith comprises of normalized test marks obtained in the various tests (1174).

FIG. 11E depicts an illustrative set of clusters.

STest depicted in FIG. 11D is analyzed to generate various clusters as per the flowchart depicted in FIG. 11B (1176). In particular, the value of N (the number of tests in STest) is 15 and Alpha, a pre-defined value, is set to 0.3.

As depicted, four clusters get determined with sizes of 6, 5, 3, and 1.

FIG. 11F depicts the computed Test Factor of Smith.

Based on Alpha, two clusters of sizes 6 and 5 become part of TRSC (1178).

The value of N1 is 11 and the computed Test Factor of student Smith is 0.76.

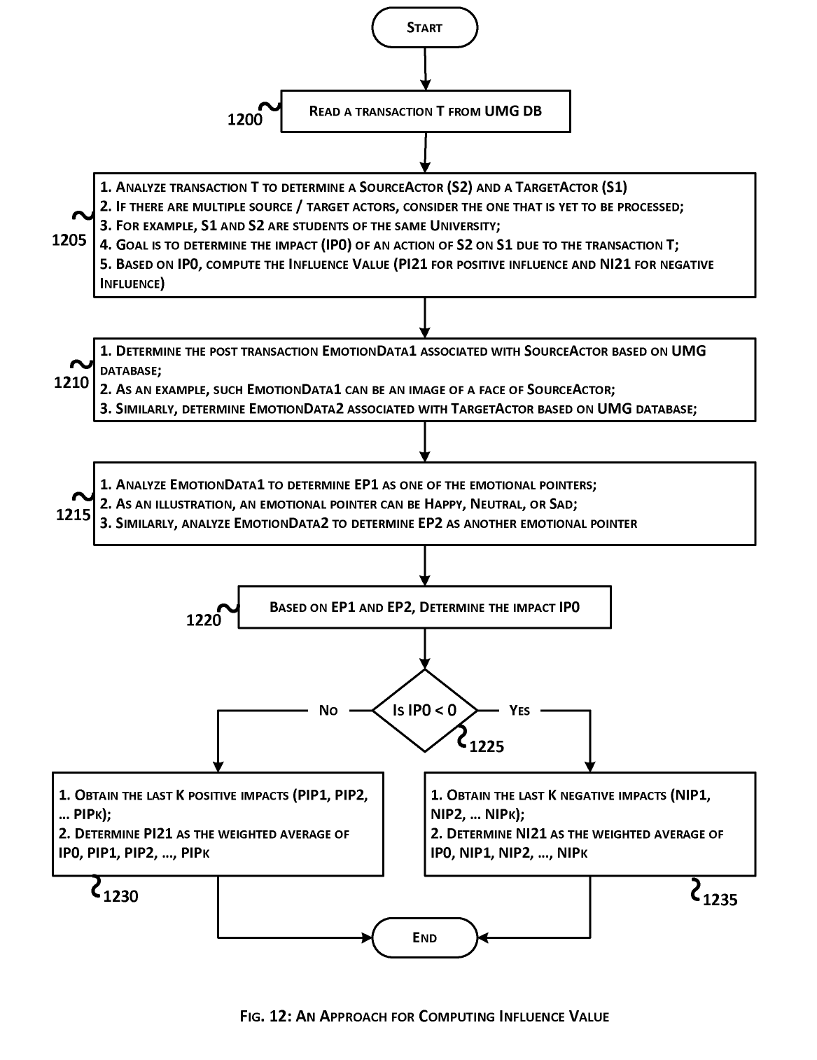

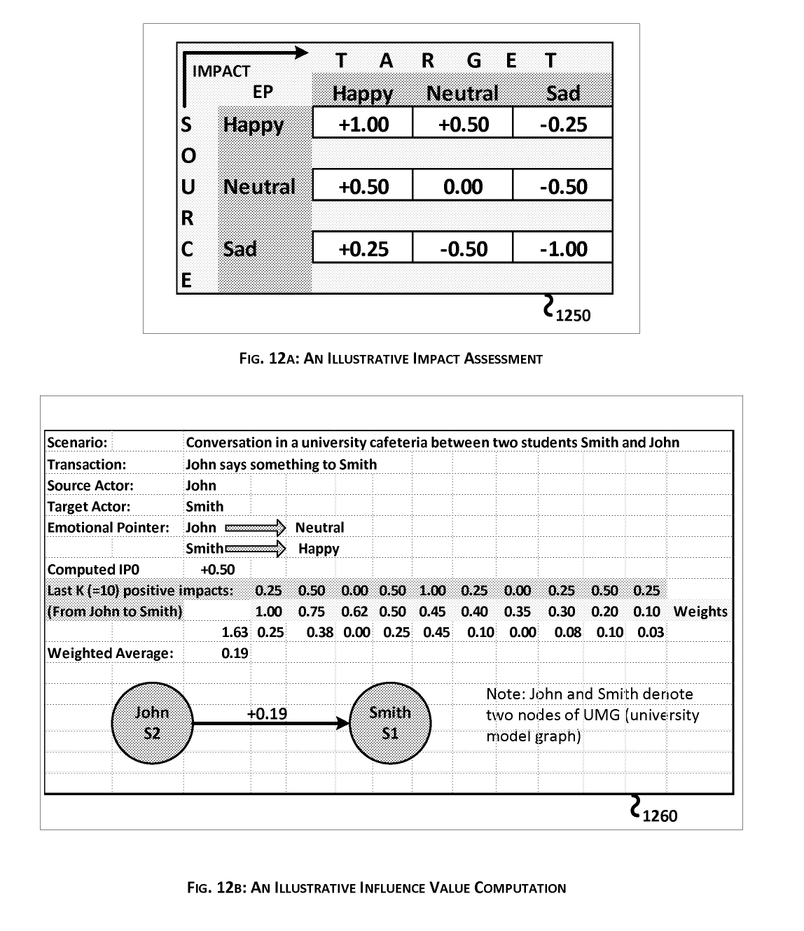

FIG. 12 provides an approach for computing influence value.

The approach relies on the post transaction emotional pointers to determine the nature and quantum of influence.

Read a transaction T from UMD Database (1200). A typical transaction could be sending of a text message by a student on a subject matter related to the university of the student to another student of the university.

The transaction T is analyzed and the following sub-steps are performed (1205):

1. Analyze transaction T to determine SourceActor (S2) and TargetActor (S1);

2. If there are multiple source/target actors, consider the pair that is yet to be processed;

3. In a typical transaction, S1 and S2 are students of the same university;

4. Goal is to determine the impact (IP0) of an action of S2 on S1 due to the transaction T;

5. Based on IP0, compute the Influence Value (PI21 for positive influence and NI21 for negative Influence) of student S2 on student S1.

As a next step, the following sub-steps are performed (1210):

1. Determine the post transaction EmotionData1 associated with SourceActor based on UMG database;

2. As an example, such EmotionData1 can be an image of a face of SourceActor;

3. Similarly, determine EmotionData2 associated with TargetActor based on UMG database.

In the next step, the following sub-steps are performed (1215):

1. Analyze EmotionData1 to determine EP1 as one of the emotional pointers;

2. As an illustration, an emotional pointer can be Happy, Neutral, or Sad;

3. Similarly, analyze EmotionData2 to determine EP2 as another emotional pointer;

In other words, EP1 is one of {Happy, Neutral, Sad};

Similarly, EP2 is one of {Happy, Neutral, Sad}.

Based on EP1 and EP2, determine the impact IP0 (1220). In a typical embodiment, a pre-defined table that maps the pair <EP1, EP2> to a value between −1 and +1 is used to determine IP0 (refer to FIG. 12A).

Check if IP0 is less than 0 (1225).

If not so, Obtain the last K positive impacts (PIP1, PIP2, . . . PIPk) (1230); Determine PI21 as the weighted average of IP0, PIP1, PIP2, . . . , PIPk; and the computed PI21 is made part of the set of positive influence values.

If it is so (1225), Obtain the last K negative impacts (NIP1, NIP2, . . . NIPk) (1235); Determine NI21 as the weighted average of IP0, NIP1, NIP2, . . . , NIPk; and the computed NI21 is made part of the set of negative influence values.

FIG. 12A depicts an illustrative impact assessment.

Observe that in one of impact assessment approaches, a pre-defined table that maps a pair of emotional pointers to a value between −1 and +1 gets used (1250).

For example, if a source actor is Neutral (an emotional pointer, EP1) and a target actor is happy (an emotional pointer EP2), then it is concluded that the source actor impacts positively the target actor, and nature and quantum of impact is +0.50.

FIG. 12B provides an illustrative influence value computation.

The scenario under consideration is a conversation between two students, Smith and John, in a university cafeteria (1260).

As part of the conversation, John says something to Smith and this is an example of a typical transaction T.

This transaction T is analyzed to determine SourceActor and TargetActor.

Further, the emotion data post transaction T with respect to both John and Smith are obtained and analyzed. As depicted, it appears that John is Neutral (EP1) and Smith is Happy (EP2) post transaction T.

Based EPI and EP2, the impact IP0 is computed using the Impact Table depicted in FIG. 12A, and in this case, the impact is positive with a value of +0.50.

In order to compute the positive influence of John upon Smith, the last K positive impact values are obtained from UMD database and note that each of these K positive impact values are from John to Smith. In the present case, K is set to 10.

A weighted average is computed with the K weights as depicted and the positive influence value PI21 from John upon Smith is computed as +0.19.

Thus, a system and method for the construction of a university model graph of a university is disclosed. Although the present invention has been described particularly with reference to the figures, it will be apparent to one of the ordinary skill in the art that the present invention may appear in any number of systems that construct influence based structural representation. It is further contemplated that many changes and modifications may be made by one of ordinary skill in the art without departing from the spirit and scope of the present invention.

We claim:

1. A computer-implemented method for the construction of a structural representation of an educational institution in the form of a university model graph using a plurality of assessments and a plurality of influence values based on a university model graph database and a plurality of students of said educational institution,
said method performed on a computer system comprising at least one processor, one or more memory units, and one or more network interfaces for connecting said computer system to an Internet Protocol (IP) network, said method comprising the steps of:
determining, with at least one processor, a first student of said plurality of students;
determining, with at least one processor, a plurality of transactions associated with said first student based on said university model graph database, wherein said plurality of transactions are within a pre-defined analysis period and a transaction of said plurality of transactions is associated with an attribute of a plurality of attributes comprising a test attribute, an assignment attribute, an exam attribute, an attend attribute, a focus attribute, and an attention attribute, and said transaction comprises a value with respect to said attribute with said value being between 0 and 1;
determining, with at least one processor, a plurality of test transactions based on said plurality of transactions, wherein an attribute of a test transaction of said plurality of test transactions is said test attribute;
computing, with at least one processor, a test factor (TF) of said first student based on said plurality of test transactions;
determining, with at least one processor, a plurality of assignment transactions based on said plurality of transactions, wherein an attribute of an assignment transaction of said plurality of assignment transactions is said assignment attribute;
computing, with at least one processor, an assignment factor (AF) of said first student based on said plurality of assignment transactions;
determining, with at least one processor, a plurality of exam transactions based on said plurality of transactions, wherein an attribute of an exam transaction of said plurality of exam transactions is said exam attribute;
computing, with at least one processor, an exam factor (EF) of said first student based on said plurality of exam transactions;
determining, with at least one processor, a plurality of attend transactions based on said plurality of transactions, wherein an attribute of a attend transaction of said plurality of attend transactions is said attend attribute;
computing, with at least one processor, an attend factor (AdF) of said first student based on said plurality of attend transactions;
determining, with at least one processor, a plurality of focus transactions based on said plurality of transactions, wherein an attribute of a focus transaction of said plurality of focus transactions is said focus attribute;
computing, with at least one processor, a focus factor (FF) of said first student based on said plurality of focus transactions;
determining, with at least one processor, a plurality of attention transactions based on said plurality of transactions, wherein an attribute of an attention transaction of said plurality of attention transactions is said attention attribute;
computing, with at least one processor, an attention factor (AtF) of said first student based on said plurality of attention transactions;
determining, with at least one processor, a plurality of weights associated with said plurality of attributes;
computing, with at least one processor an assessment of said plurality of assessments associated with said first student based on said TF, said AF, said EF, said AdF, said FF, said AtF, and said plurality of weights;
determining, with at least one processor, a second student of said plurality of students;
determining a transaction based on said university model graph database, wherein said transaction involves said first student and said second student; and
determining an influence value of said plurality of influence values from said second student to said first student based on said transaction.

2. The method of claim 1, wherein said step for computing said test factor further comprising the steps of:
determining said plurality of test transactions;
determining a size (N) based on said plurality of transactions;
determining an alpha as a first pre-defined threshold;
determining a beta as a second pre-defined threshold;
computing a plurality of clusters of said plurality of test transactions;
ranking of said plurality of clusters to result in a plurality of ranked clusters based on the size of each of said plurality of clusters;
selecting a plurality of top ranked clusters based on said plurality of ranked clusters, wherein the size of each cluster of said plurality of top ranked clusters is greater than or equal to said N* said alpha;
selecting said plurality of top ranked clusters based on a minimum number of said plurality of ranked clusters, wherein the sum of a plurality of sizes of said plurality of top ranked clusters is greater than or equal to said N* said beta;
determining a number of clusters (K) in said plurality of top ranked clusters;
determining a plurality of ranked cluster sizes based on said plurality of top ranked clusters, wherein a cluster size of said plurality of ranked cluster sizes is the size of a cluster of said plurality of top ranked clusters;
computing a ranked clusters size (N1) based on said plurality of ranked cluster sizes;
computing a plurality of centroids of said plurality of top ranked clusters; and
computing said test factor based on said plurality of centroids, said plurality of ranked cluster sizes, and said N1.

3. The method of claim 1, wherein said step for computing said influence value further comprising the steps of:
determining said first student;
determining said second student;
determining said transaction involving said first student and said second student;
analyzing said transaction to determine a source actor, wherein said source actor is said second student;
analyzing said transaction to determine a target actor, wherein said target actor is said first student;
determining a first post transaction emotional data based on said source actor and said university model graph database;
determining a second post transaction emotional data based on said target actor and said university model graph database;
determining a plurality of emotional pointers comprising of Happy, Neutral, and Sad;
determining a plurality of emotional pointer (EP) mappings based on said plurality of emotional pointers, wherein a mapping of said plurality of EP mappings provides a value between −1 and +1 and maps a first emotional pointer of said plurality of emotional pointers to a second emotional pointer of said plurality of emotional pointers;
analyzing said first post transaction emotional data to determine a first emotional pointer (EP1), wherein said EP1 is based on said plurality of emotional pointers;
analyzing said second post transaction emotional data to determine a second emotional pointer (EP2), wherein said EP2 is based on said plurality of emotional pointers;
determining an impact value (IP0) based on said EP1, said EP2, and said plurality of EP mappings,
determining a plurality of past positive impact values based on said student 2, said student 1, and said university model graph database;
determining a plurality of past negative impact values based on said student 2, said student 1, and said university model graph database;
computing a positive influence value of said plurality of influence values based on said IP0, said plurality of past positive impact values, wherein said IP0 is greater than or equal to zero; and
computing a negative influence value of said plurality of influence values based on said IP0, said plurality of past negative impact values, wherein said IP0 is less than zero.
